(19) United States
(12) Patent Application Publication
(10) Pub. No.: US 2026/0072584 A1
(43) Pub. Date: Mar. 12, 2026

(54) SYSTEMS AND METHODS FOR DYNAMIC VIEW CUSTOMIZATION

(71) Applicant: Zoho Corporation Private Limited, Chengalpattu Taluk (IN)

(72) Inventors: Gobinath Selvam, Tirunelveli (IN); Senthilkumar Subramanian, Srivilliputtur (IN); Samraj Selvaraj, Aalangudi (IN); Vijay Sekar, Arani (IN); Kowsik Samynathan, Anthiyur (IN); Selvakumar Thirumoorthy, Palladam (IN)

(21) Appl. No.: 19/308,069

(22) Filed: Aug. 22, 2025

Related U.S. Application Data
(60) Provisional application No. 63/717,817, filed on Nov. 7, 2024.

(30) Foreign Application Priority Data
Sep. 9, 2024 (IN) 202441068042

(51) Int. Cl. G06F 3/0486; G06F 3/0481

(52) U.S. Cl. CPC G06F 3/0486; G06F 3/0481

(57) ABSTRACT

Disclosed are techniques to facilitate Customer Relationship Management (CRM) data utilization and display to suit organizational and team goals, methods, requirements, and more. A system includes a CRM page building engine, a layout building engine, a rendering engine, a request handling engine, a CRM datastore, an element datastore, and a layout datastore. For example, a design system is implemented as a no-code builder that facilitates creation through a drag-and-drop interface, which is intuitive and user-friendly. A layout building engine processes the CRM element data, which comprises the absolute position of the CRM element on the canvas. The layout building engine performs grouping and/or sub-grouping process to wrap the CRM element in the layout. The layout building engine outputs layout data for each element. The resulting element set is a separable element set or a non-separable element set. The resulting set is aligned to place its elements in the exact position or order. On successful fetching of all the required data, the layout data will be mapped with the CRM data and its application elements, based on its type and the action to be performed.

### CROSS-REFERENCE TO RELATED APPLICATIONS

The present application claims priority to Indian Provisional Patent Application No. 202441068042 filed Sep. 9, 2024 and U.S. Provisional Patent Application Ser. No. 63/717,817 filed Nov. 7, 2024, each of which is hereby incorporated by reference herein.

### BRIEF DESCRIPTION OF THE DRAWINGS

FIG. 1 is a diagram of an example of a Customer Relationship Management (CRM) system.

FIG. 2 is a diagram of example elements of an example CRM page design system involved in page building.

FIG. 3 is a diagram of an example of a Super parent, Parent wrapper, Child wrapper, and Child element.

FIG. 4 is a diagram of example elements of an example CRM page design system involved in page rendering.

FIG. 5 is diagram of an example of a CRM element placed on a canvas and example positional coordinates (PC) of the CRM element.

FIGS. 6A-C are examples of wrapping two elements based on coordinates in vertical direction.

FIG. 6D is an example of wrapping three elements which lies on different coordinates along vertical direction.

FIG. 7 is a master flowchart depicting example operations of a layout building engine.

FIG. 8A is a flowchart of an example CRM layout building engine operation (e.g., grouping) to reduce wrapper count.

FIG. 8B is a flowchart of an example CRM layout building engine operation (e.g., sub-grouping) to reduce wrapper count.

FIG. 8C is a flowchart of an example functioning of a wrapper configuration unit in CRM.

FIG. 9 is a diagram of an example wrapper along the vertical axis around elements (1, 4, 2).

FIG. 10 is a diagram of an example wrapper along a horizontal axis around elements (1, 2).

FIG. 11 is a diagram of an example further grouping or sub-grouping of elements (1, 2).

FIG. 12 is a diagram of an example wrapper along vertical axis around elements (3,5).

FIG. 13 is a diagram of an example wrapper along vertical axis for elements (1,3,2,4).

FIG. 14 is a diagram of an example wrapper along horizontal axis for elements (1,2,4,3).

FIG. 15 is a diagram illustrating an example handling of a non-separable element set.

FIG. 16 is a diagram illustrating an example hidden element handled by an absolute positioning module.

FIG. 17 is a screenshot of an example without pregrouping.

FIG. 18 illustrates a screenshot of an example after pregrouping.

FIG. 19A illustrates a screenshot of an example count difference using the enhanced layout building engine.

FIG. 19B illustrates a screenshot of an example count difference and JSON, DOM size difference using the enhanced layout building engine.

FIG. 20A illustrates a screenshot of an example rendering of CRM element without enhanced grouping by the layout building engine.

FIG. 20B illustrates a screenshot of an example rendering of CRM element with enhanced grouping by the layout building engine.

FIG. 21A illustrates a screenshot of an example user design layout.

FIG. 21B is a flowchart of an example enhanced grouping.

FIG. 22A is a screenshot of an example actual screen size of a CRM Page.

FIG. 22B is a screenshot of an example expanded screen size without wrapper configuration.

FIG. 22C is a screenshot of an example expanded screen size with wrapper configuration.

FIG. 23 is a diagram of an example tree data structure of a wrapper.

FIG. 24 illustrates pseudo code for an example separable set.

FIG. 25A and FIG. 25B illustrate pseudo code for an example non-separable set.

### DETAILED DESCRIPTION

Traditionally, list and detail views in Customer Relationship Management (CRM) applications are not natively customizable. For example, either the CRM application does not support redesign attempts, or it requires the customers to find a workaround (e.g., through integrations, paid services, or developer tools). There is no implicit, built-in capability to redesign a view.

Systems and methods for dynamic Customer Relationship Management (CRM) page design are described herein. In a specific implementation, ZOHO® CRM is provided via CANVAS™, a no-code, drag-and-drop dynamic design system. The design system is readily integrated with other software applications (e.g., ZOHO Creator, ZOHO Expenses, ZOHO Payroll, ZOHO Recruiter, or the like) to dynamically generate view customization, where customers reimagine the user interface (UI) of CRM on a blank canvas. Design and data packaging have a subjective aesthetic element, so the CRM page design system has a wide range of features and formatting options that can be dynamically implemented (e.g., at runtime). This helps create an application that feels like it is personalized and customized down to the last detail. However, the aesthetics are coupled with custom CRM elements that ensure functionality and ease of use. To this end, a dynamic user interface (e.g., graphical user interface) has been developed that provides multiple ways to offer a highly personalized user experience to multiple teams with a motivation “to each their own.” Techniques described in this paper enable a design system to provide dynamic view customization using enhanced grouping techniques based on computing requirements (e.g., processing requirements, memory requirements, network requirements) and/or organizational requirements needed in a CRM application with tools that facilitate ease of use while maintaining functionality and computational efficiency.

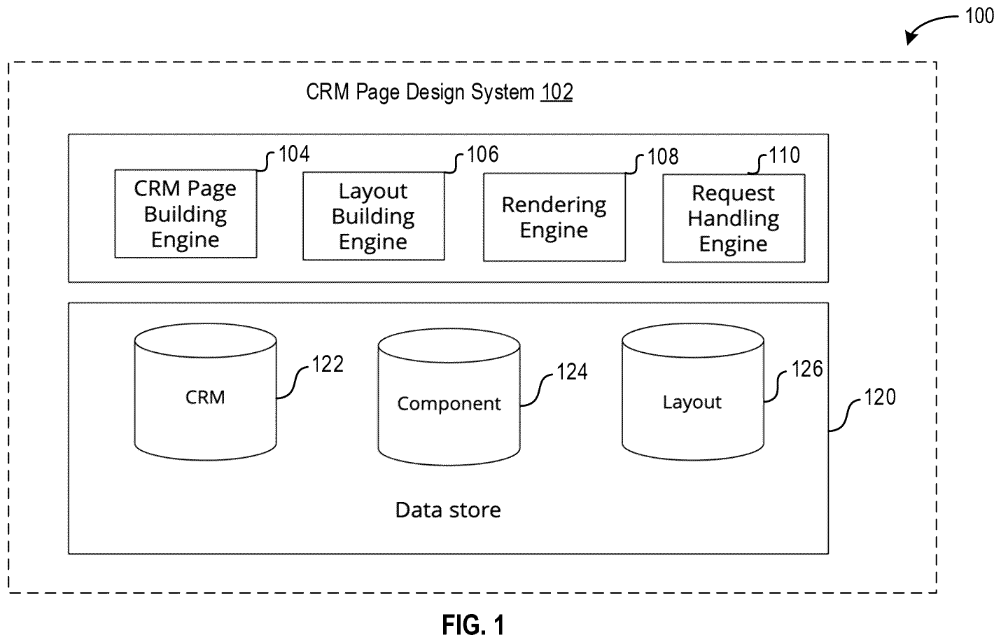

FIG. 1 is a diagram 100 of an example of a CRM page design system 102. In a specific implementation, the CRM page design system 102 is a no code, layout-based design system. In the example of FIG. 1, CRM page design system 102 comprises a CRM page building engine 104, a layout building engine 106, a rendering engine 108, a request handling engine 110, and a datastore 120. The datastore 120 includes CRM datastore 122, component datastore 124, and layout datastore 126.

In a client-server implementation with a server coupled to a client via a network, engines of the CRM page design system exist at the server, at the client, or portions thereof at both the server and the client. The CRM page design system is also implemented as an independent computer system. In a specific implementation, the datastore comprises raw JavaScript Object Notation (JSON) data, henceforth called element data, Hyper Text Markup Language (HTML) JSON data, henceforth called layout data, and CRM data. In a specific implementation, the CRM data (and/or other data) is maintained in a database, but some or all the data is maintained in a database or, more generally, a datastore.

Networks discussed in this paper are intended to include all communication paths that are statutory (e.g., in the United States, under 35 U.S.C. 101), and to specifically exclude all communication paths that are non-statutory in nature to the extent that the exclusion is necessary for a claim that includes the communication path to be valid. Known statutory communication paths include hardware (e.g., registers, random access memory (RAM), non-volatile (NV) storage, to name a few) but may or may not be limited to hardware.

Communication paths discussed in this paper are intended to represent a variety of potentially applicable technologies. For example, a network is used to form a network or part of a network. Where two elements are co-located on a device, a network can include a bus or other data conduit or plane. Where a first element is co-located on one device and a second element is located on a different device, a network can include a wireless or wired back-end network or LAN. A network can also encompass a relevant portion of a WAN or other network, if applicable.

The devices, systems, and communication paths described in this paper are implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory is local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage is local, remote, or distributed. The non-volatile storage is optional because systems is created with all applicable data available in memory.

Software is typically stored in the non-volatile storage. Indeed, for large programs, it may not even be possible to store the entire program in memory. Nevertheless, for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system is controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface is considered to be part of the computer system. The interface can include an analog modem, ISDN modem, cable modem, token ring interface, satellite transmission interface (e.g., “direct PC”), or other interfaces for coupling a computer system to other computer systems. Interfaces enable computer systems and other devices to be coupled together in a network.

The computer systems is compatible with or implemented as part of or through a cloud-based computing system. As used in this paper, a cloud-based computing system is a system that provides virtualized computing resources, software and/or information to end user devices. The computing resources, software and/or information is virtualized by maintaining centralized services and resources that the edge devices can access over a communication interface, such as a network. “Cloud” may be a marketing term and, for the purposes of this paper, can include any of the networks described herein. The cloud-based computing system can involve a subscription for services or use a utility pricing model. Users can access the protocols of the cloud-based computing system through a web browser or other container application located on their end user device.

A database management system (DBMS) is used to manage a datastore. In such a case, the DBMS may be thought of as part of the datastore, as part of a server, and/or as a separate system. A DBMS is typically implemented as an engine that controls the organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice. org Base, to name several.

Database servers can store databases, as well as the DBMS and related engines. Any of the repositories described in this paper could presumably be implemented as database servers. It is noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modelling language, data structure, database query language, and transaction mechanism. The modelling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

As used in this paper, a data structure is associated with a particular way of storing and organizing data in a computer so that it is used efficiently within a given context. Data structures are generally based on the ability of a computer to fetch and store data at any place in its memory, specified by an address, a bit string itself stored in memory and manipulated by the program. Thus, some data structures are based on computing the addresses of data items with arithmetic operations, while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, is cloud-based datastores. A cloud-based datastore is a datastore that is compatible with cloud-based computing systems and engines.

A computer system is implemented as an engine, as part of an engine, or through multiple engines. As used in this paper, an engine includes one or more processors or a portion thereof. A portion of one or more processors can include some portion of hardware less than all the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine is centralized, or its functionality distributed. An engine can include hardware, firmware, or software embodied in a computer-readable medium for execution by the processor that is an element of the engine. The processor transforms data into new data using implemented data structures and methods, such as is described with reference to the figures in this paper.

Engines described in this paper, or the engines through which the systems and devices described in this paper are implemented, are cloud-based engines. As used in this paper, a cloud-based engine is an engine that can run applications and/or functionalities using a cloud-based computing system. All or portions of the applications and/or functionalities is distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

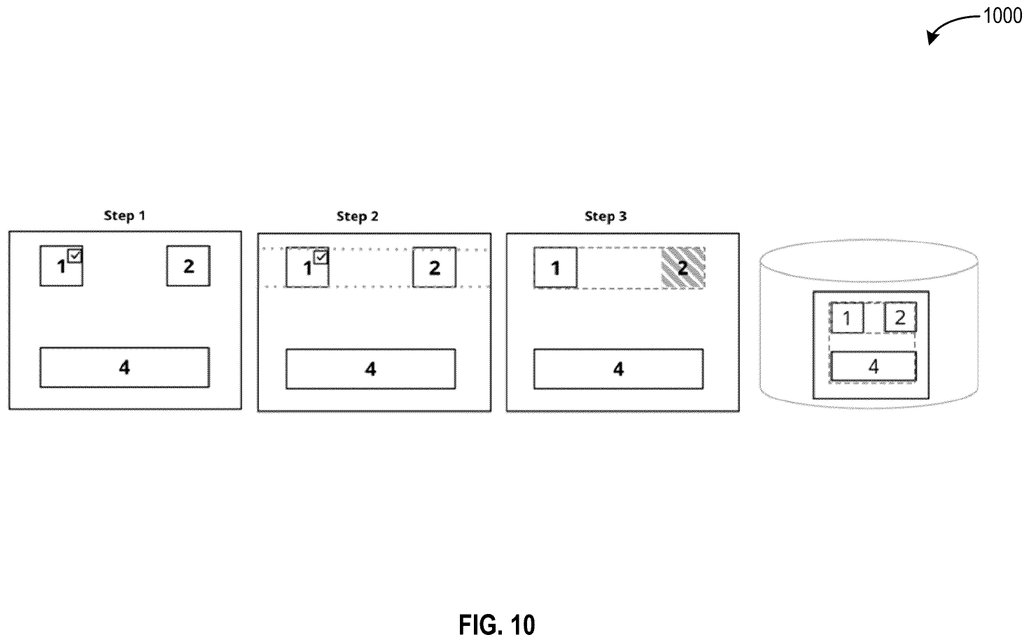

In some embodiments, the CRM page design system 102 will provide a blank canvas area for designing a CRM page with a free flow. The user can drag and drop CRM elements onto the canvas as needed. A layout can be created based on the CRM elements placed on the canvas. In a specific implementation, where two or more CRM elements overlap with each other due to various requirements (e.g., organization requirements, computing requirements), the layout building engine 106 will group these elements using enhanced grouping techniques. The enhanced grouping techniques (or, processes) are described in FIGS. 9-12. Flowcharts 8A-B further illustrate this grouping process. In some implementations, the layout building engine 106 may be referred to as the enhanced layout building engine 106.

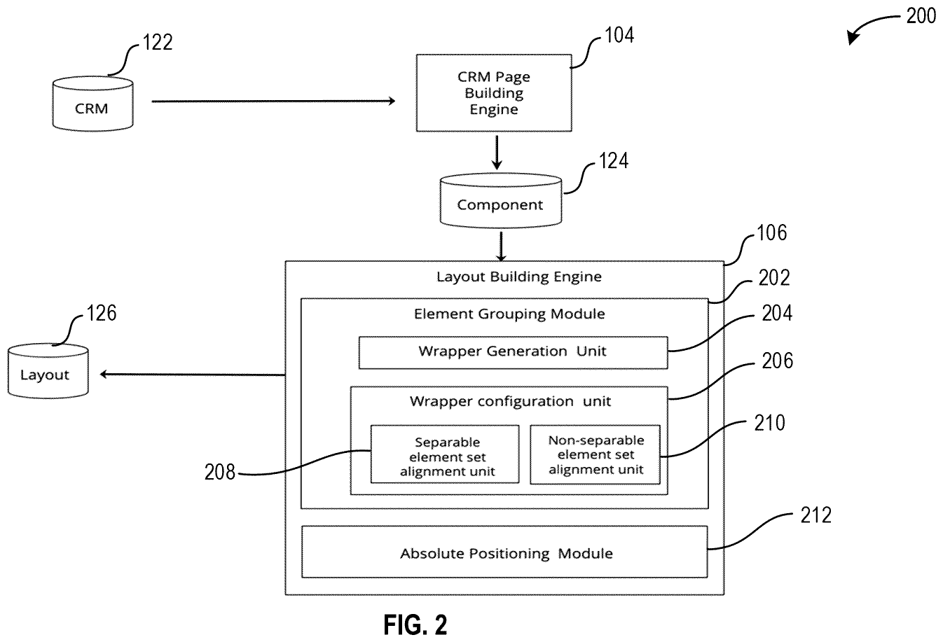

FIG. 2 is a diagram 200 of example elements of an example CRM page design system 102 involved in page building. While building a CRM page, the CRM page building engine 104 and layout building engine 106 are involved. The CRM page building engine 104 is a UI building tool that generates frontends based on application programming interface (API) data from CRM datastore(s), e.g., a Zoho CRM database. Other application datastores, e.g., Zoho Creator, Zoho Expense, Zoho Payroll, Zoho Recruiter, etc., can also be deployed while building a CRM page for corresponding applications.

In a specific implementation, the CRM page building engine 104 facilitates creating a UI as per organizational requirements, team requirements, user preferences requirements, computing requirements, and/or other requirements, through easy drag and drop operations (e.g., no-code drag and drop operations). In a specific implementation, the CRM page building engine 104 provides an easy-to-use builder UI with selection pane, data pane, style menu, and the like. A selection pane on the UI renders various elements (e.g., Button, Table, Fields, Section, and the like). CRM elements are dragged from the selection pane and dropped on a canvas while designing a CRM page.

The CRM page building engine 104 UI in ready state can have data from the CRM datastore defined so that it is customized easily according to the design. The CRM page building engine 104 can convert the fetched data to a builder-recognizable format and load it into a data pane. The data can include, for example, fields, related lists, and actions. CRM elements are dragged from the data pane and dropped on a canvas while designing a CRM page. A set of supporting elements to organize the data, like table, section, and the like, may or may not also be available on the data pane.

The CRM page building engine 104 also provides options to render style property to the elements placed on the canvas (e.g., through the style menu). When data fields are dragged from the data pane and dropped on the canvas area, a corresponding CRM element's position can be marked with dimensions. In a specific implementation, after being dropped on the canvas, each CRM element can be assigned a unique identity, which may or may not be pseudo-randomly generated. A style property is selected from the style menu and assigned to a CRM element. For example, the style property is appended to the unique identity of the corresponding CRM element. An element refers to a single or individual element or component. An element set refers to a collection or group of individual elements.

Once the designing of the CRM page is completed, element data of each CRM element (including, for example, field dimension, position, style) is saved with its unique identity in, for example, a tree format.

In some embodiments, designing of the CRM page is done in multiple ways. Two examples of such are:
a) The CRM page design system 102 comprises a gallery that includes a default set of templates to create CRM pages. A user can choose a suitable template and customize it based on preferences and/or requirements. It incorporates a smart grid option that provides a guide to place a CRM element to line up with previously placed CRM elements to ensure alignment. The gallery could also contain a default set of layouts.
b) The CRM page design system 102 provides flexibility to build a CRM page from scratch. In such a scenario, the CRM page design system 102 will provide a blank, free flow canvas area to design a CRM page. The user can drag and drop desired CRM elements on the canvas. A layout is generated according to the CRM elements on the canvas.

In some embodiments, the layout building engine 106 generates a layout for a page designed with CRM elements that were dragged and dropped onto the canvas. The CRM elements and corresponding CRM element data are included in a CRM element list. The layout building engine 106 processes the CRM element data of each CRM element in the CRM element list and generates HTML equivalent JSON, referred to as Layout data. The CRM element data of a CRM element comprising absolute positions of the CRM element may not be usable as such due to potentially dynamic data size. Thus, the CRM element data of each CRM element is processed by the layout building engine 106 to generate layout data. A layout is created using the layout data to accommodate all elements and data records placed on the canvas.

When CRM elements are placed on a canvas, there could be design scenarios where CRM elements get overlapped, based on the organizational (e.g., business) requirements. The layout building engine 106 handles the overlapping elements before initiating a process for grouping/sub grouping of CRM elements. The overlapping of the CRM elements can be handled using the following mechanism:

Step 1: Say there are two CRM elements overlapping each other, CRM element 1 and CRM element 2, wherein CRM element 2 hides CRM element 1. Fetch position coordinates (PC) of the overlapping CRM elements.

Step 2: Resize the CRM element 2 which hides CRM element 1, while storing the original PCs of the CRM element 2 along with the layout data of the CRM element 2.

Step 3: A grouping process for the overlapping CRM elements is initiated.

Step 4: The wrapper configuration unit 206 supports rendering the CRM element 2 with its original size.

The layout building engine 106 comprises an element grouping module 202 and an absolute positioning module 212. The element grouping module 202 performs grouping and/or sub-grouping process by using a wrapper to wrap or organize the CRM elements in the layout for free flow canvas area when designing a CRM page. Grouping is performed based on the disturbing CRM elements referred from the layout data. The layout data of each CRM element comprises position, background, size, element unique information, text style, image data, actionable information, and the like. It also includes information about its neighbor(s), which are referred to as “disturbing CRM elements” if they satisfy conditions as described below. In some embodiments, not all neighboring elements are disturbing CRM elements, but neighbors satisfying this condition are described below. The grouping or sub-grouping process results in reduced wrappers, which in turn optimizes the layout building engine 106 by improving its performance.

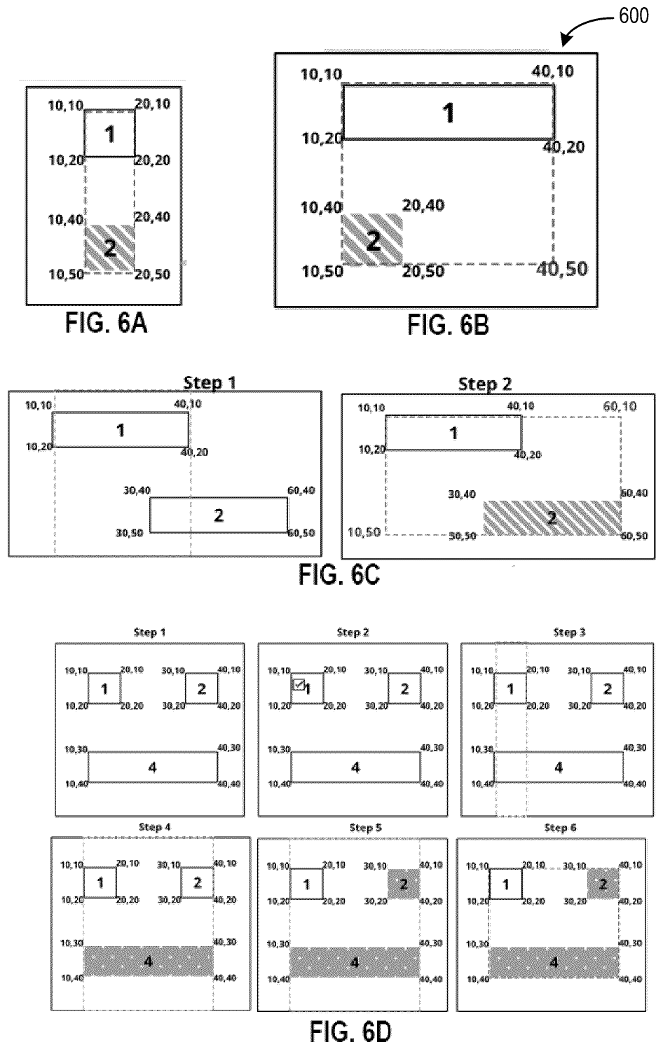

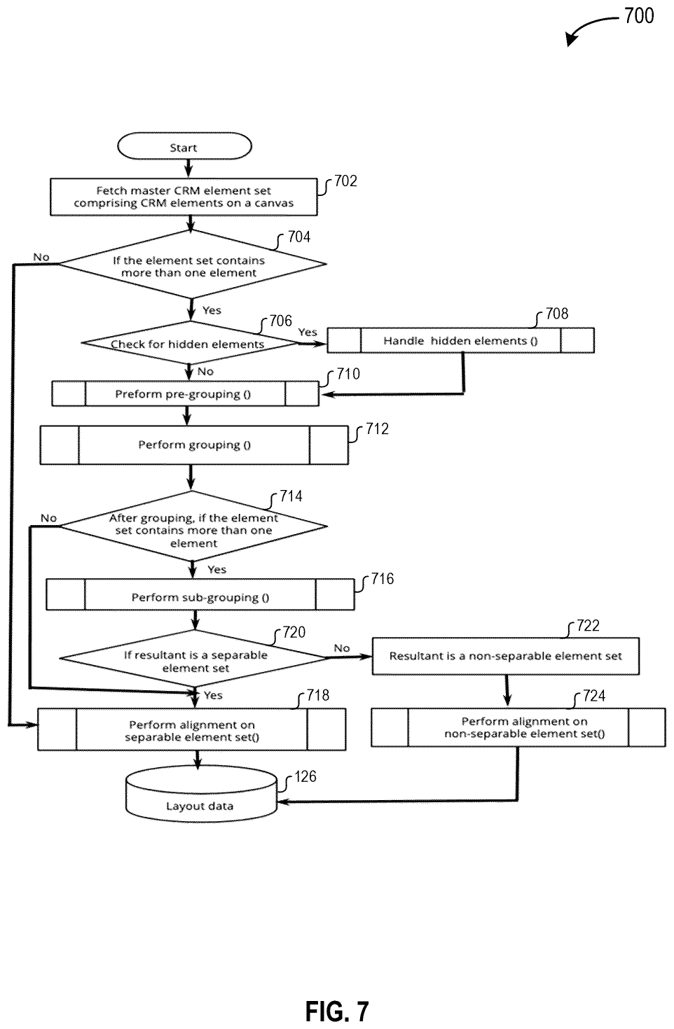

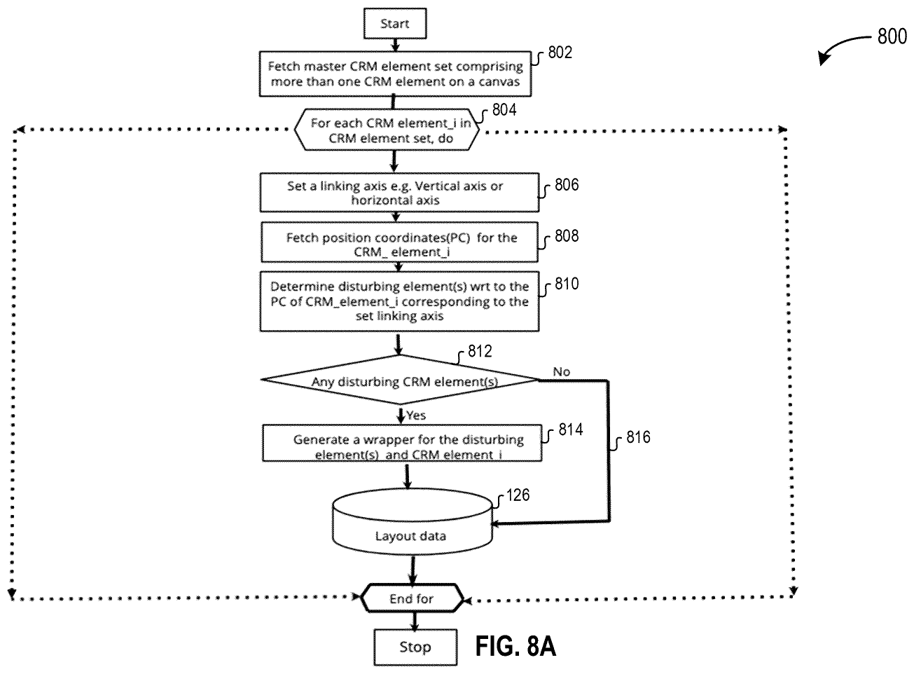

The wrapper generation unit 204 of the element grouping module 202 creates and/or generates a wrapper. In some embodiments, a wrapper is an element created and/or generated to organize the CRM elements in the layout. Creating a wrapper can involve grouping elements or elements, adding a wrapper to more than one element, and applying CSS style to achieve the desired design and handle the layout while dynamic data content arrives. CSS is a style sheet language used to describe the presentation of a document written in HTML or XML. CSS is essential for defining the look and feel of a page, including layout, colors, fonts, and other visual aspects. The process involving grouping and generating wrappers is illustrated in FIGS. 6 and 7.

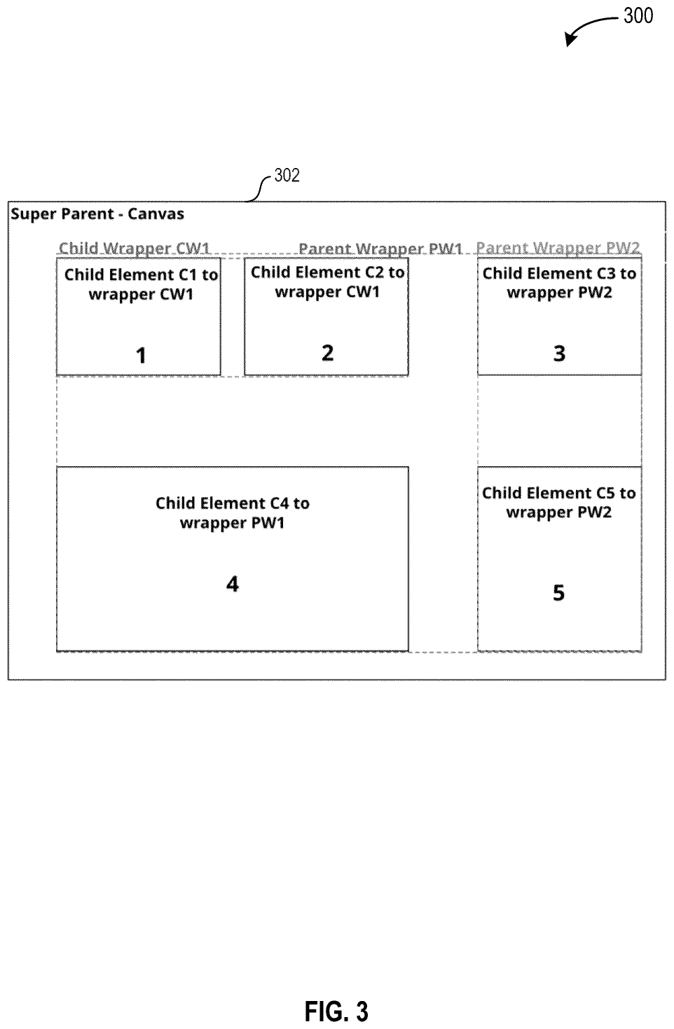

FIG. 3 is a diagram 300 of an example of a super parent 302, parent wrapper, child wrapper, and child element. In the example of FIG. 3, the wrappers of the grouped CRM elements exhibit or adapt to various controls and characteristics as a parent and as a child. The super parent 302 is a canvas or a builder area. The parent is the element which contains another element; children is the contained element. A child element also have nested elements inside it, making it a parent element to its nested elements. The child element's behavior/appearance is influenced by their parent settings. Here, the parent is an element or a wrapper. Child is an element or a wrapper. Parent wrappers PW1 and PW2 are siblings, Child wrappers CW1 and Child element C4 are siblings, Child element C1 and Child element C2 are siblings, Child element C3 and C5 are siblings. Siblings are elements that share the same parent element.

As a parent wrapper,
Handle the alignment of the resultant grouping elements, such as a separable element set and a non-separable element set
Determines the child element's placing position on a CRM view page
Determines the child element's alignment directions (Row and Column or both) on a CRM view page
Maintain the required gap between child elements (static and responsive gaps)
Adopt the child's height if its content will grow.

As a child wrapper,
Maintain the required gap between its sibling elements
Grow and fill the runtime created empty gaps due to the absence of sibling elements

In a specific implementation, wrappers are merged into a single wrapper or split into multiple wrappers. Wrappers size tend to change based on the grouping or sub-grouping process. Based on the child element's height/width, during the grouping process, the wrapper tend to adapt the height and width of the child element. If data in a child element tends to grow, the wrapper size adapts the child element size, wherein the child element is with or without wrapper. In some embodiments, if the position of an element is updated, only the parent element of the corresponding element is updated rather than re-generating the entire view.

The grouping or sub-grouping process can result in obtaining two types of element sets, a separable element set and a non-separable element set. An element set includes CRM elements within a wrapper. Grouping can be processed in a random order. Because of this, the separable element set and non-separable element set will not be rendered in a proper order in the layout. A wrapper configuration unit 206 aligns the separable element set and non-separable element set in the layout for optimal rendering. The resulting set in a grouping is identified as a separable element set when it satisfies the following condition. Disturbing element count is zero, so no further grouping takes place as there are no disturbing element or when there is no child element for the parent, no further grouping takes place. The resulting set in a grouping is identified as a non-separable element set when it satisfies the following condition. When all the elements are a disturbing element to each other i.e., the disturbing elements are not reduced to zero even after performing grouping both on a vertical axis and on a horizontal axis, the grouping continues indefinitely. To handle this continuous indefinite grouping, the non-separable element set is aligned as a grid by the wrapper configuration unit 206.

The separable element set alignment unit 208 of the wrapper configuration unit 206 supports a wrapper of the separable element set, for the wrapper to place its elements in the exact position or order and to maintain spacing between the elements as in the canvas. To place the element in its exact order, the wrapper's child elements can be sorted based on the element's starting position value and ending position value along a linking axis selected for grouping. This gives precise spatial data of the child element. The child elements are positioned according to a specified order based on the selected linking axis for grouping. The wrapper based on the child element's direction indicated by a row (aligned with x axis) and a column (aligned with y axis), aligns the direction of the elements positioned in the specified order, wherein the row indicates a left-side or a right-side direction of the element, the column indicates top or bottom directions of the element. By this approach, the alignment of the separable element set is rendered in its actual position as in the canvas.

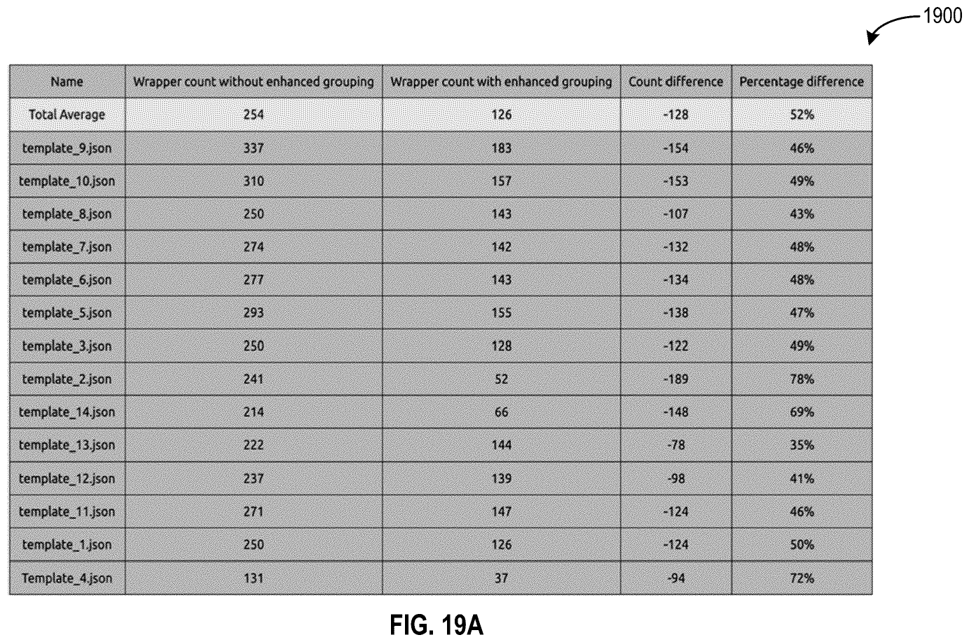

Now that the elements are positioned in the specified order, its wrapper initiates the process to ensure accurate spacing between the elements for enhancing the layout of elements to adapt seamlessly across different screen sizes and orientations. A sample of maintaining gap even after resizing the screen size is depicted in FIGS. 18A-C. The separable element alignment unit supports wrapper in determining and maintaining the spacing of elements such as a gap between its elements, space between its elements, space around its elements, or position its elements at the center. The wrapper achieves it by adjusting the gap of its elements in the element set to a corresponding predefined pixel value gap of the elements. The wrapper refers to the separable element set alignment unit 208 for the predefined pixel value. The wrapper maintains the gap of all its elements based on the arrangement of elements in the canvas or builder area. This avoids the issues on different screen sizes or when the window is resized. The pixel values are used to define dimensions such that the elements stay a specific size regardless of its screen size.

Alignment properties can include margin, padding, width, height, and the like. In a specific implementation, positions are defined in terms of percentage value so that the CRM page design may adapt well to varying screen dimensions or resolutions. In the enhanced grouping (e.g., margin and padding) can be directly given to the element. The percentage value(s) are used to define dimensions such that the elements resize relative to its parent and its next element in that element set.

In some embodiments, the non-separable element set configuration unit supports the wrapper in placing the CRM elements in a grid to handle the alignment of the non-separable element set, wherein the non-separable element set includes overlapping or non-overlapping of multiple CRM elements. The actual vertical and horizontal starting points of the elements are retrieved. At the next step, the points are sorted by axis. Elements are placed into the grid. Grid template values are added by creating grid-template-row and grid-template-column values by subtracting gaps between the starting points. By this approach, the alignment of the non-separable element set is handled in the grid to render it in its actual position as in the canvas.

There could be design scenarios where one or more CRM elements are fully overlapped and hidden. To place the fully overlapped and hidden element in its absolute position, the absolute positioning module 212 sets the fully overlapped and hidden CRM element to an absolute position relative to its parent element. Once the hidden element is rendered in an absolute position relative to its parent, this element's height & width will not affect its sibling elements. It will work separately.

The layout building engine 106 can output layout data for each element. It can be stored in a temporary storage (e.g., Zoho File System (ZFS), Redis).

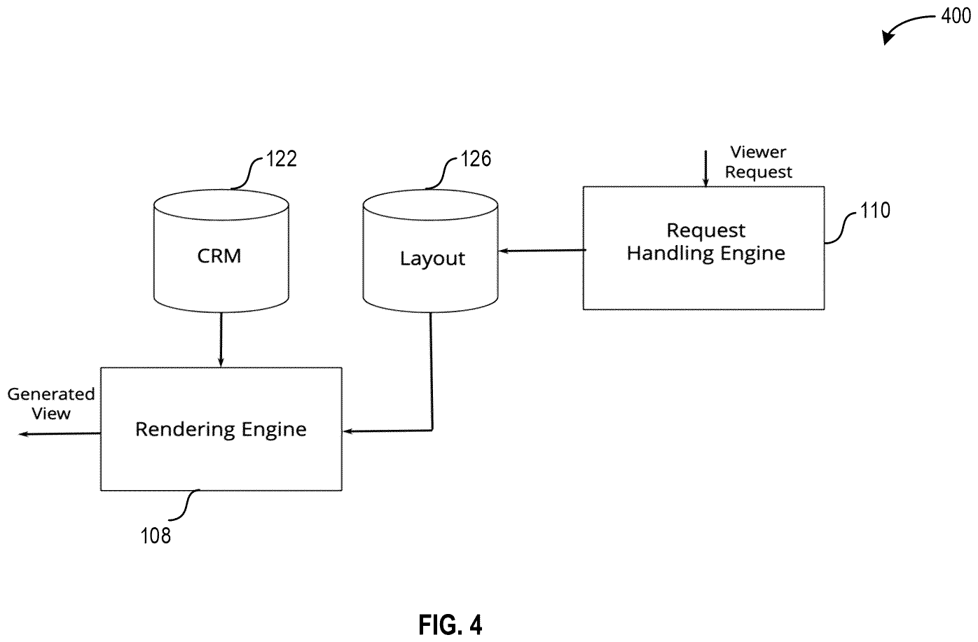

FIG. 4 is a diagram 400 of example elements of an example CRM page design system 102 involved in page rendering. In the example of FIG. 4, the CRM page design system 102 includes the layout building engine 106, a rendering engine 108, and a request handling engine 110. In a specific implementation, when a CRM page built using canvas is visited, a request handling engine 110 handles the visitor's request. Application metadata and CRM page contextual data (or record) is fetched from the CRM datastore. Layout data is also fetched from a layout datastore. If it fails, then CRM element data is fetched from a CRM element datastore and processed by the layout building engine 106 again.

On successful fetching of all the required data, the layout data can be mapped with the CRM data and its application elements, based on its type and action to be performed. The application will already have a set of predefined elements for the data field value formatting and actions. For example, Currency and Date formatting can be handled by the application. Those application elements can be mapped into the HTML code based on the unique identity of data on the canvas.

In some embodiments, the rendering engine 108 comprises an HTML code generator and a view generator. The HTML code generator generates the HTML code based on the application element comprising Layout and CRM data. It generates code as chunks corresponding to each application element. Each chunk is registered as a CRM element for data binding and caching purposes. The generated CRM elements are placed on a CRM page. The view generator generates a view of the canvas using the HTML code chunks generated by the code generator. The HTML code generated resembles the human-coded HTML.

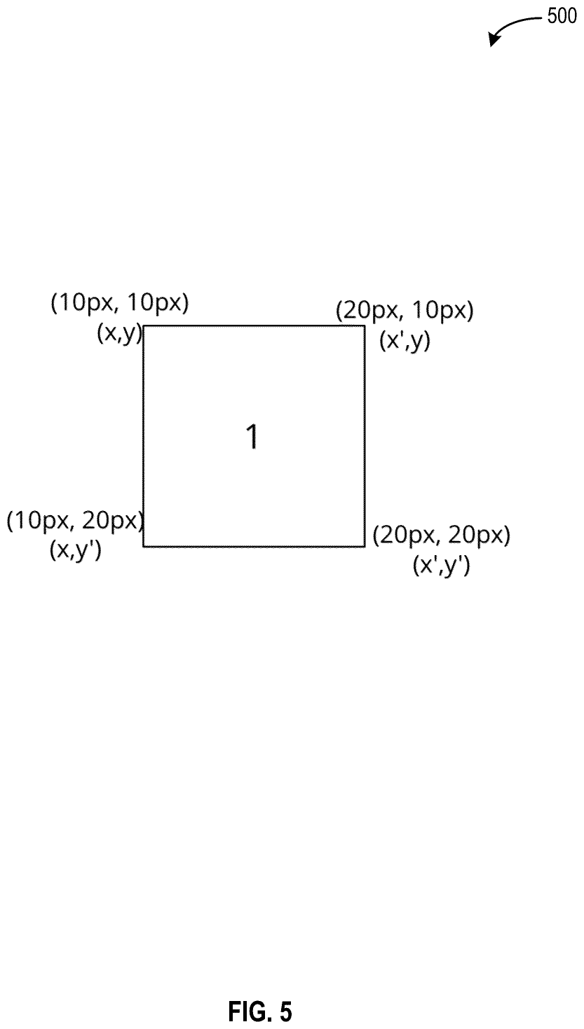

FIG. 5 is diagram 500 of an example of a CRM element placed on a canvas and example positional coordinates (PC) of the CRM element. CRM elements placed on a canvas are referred to using their PC. An example of a CRM element placed on the canvas, and the PC of the CRM element is depicted in the illustration of FIG. 5. The CRM element is characterized as having a graphical display element with a boundary (or boundaries on each of its sides) that includes the portion of the CRM element that is displayed. Although, depending upon context, the CRM element itself may be considered a graphical display element, in general, CRM elements in a layout include a graphical display element, a fixed PC at a first boundary of the graphical display element, and a dynamic PC at a second boundary of the graphical display element opposite the first boundary in the static direction of a unidirectional expansion vector.

In a specific implementation, CRM elements are linked and locked together as one wrapped element to design a dynamic layout. CRM elements to be linked and locked along the vertical axis require their coordinate/pixel values along the vertical axis. The coordinate values of the element “1” is denoted using the format, 1 (x, x′), where x-denotes the starting position value and x′ denotes the ending position value. The coordinate values along the horizontal axis is denoted as 1 (y, y′).

When the CRM elements are to be linked along the vertical X-axis, the CRM elements' x coordinate position (starting and ending) values are needed. The starting and ending coordinate values of the element is denoted using the label (x, x′) along the X-axis. Similarly, the starting and ending coordinate values of the element is denoted using the label (y, y′) along the Y-axis.

There could be multiple instances for one CRM element to be a disturbing CRM element to another CRM element. CRM element “1” PC values along the y-axis are fetched for determining a set of disturbing CRM elements along the horizontal axis. The starting and ending PC values of CRM element “1” are compared with the starting and ending PC values of CRM element “2”. There are different instances when the PC value of CRM element “2” may lie within the range of the PC value of CRM element “1” as stated below:
(a) The starting PC value of CRM element “2” lies between the starting and ending PC value of CRM element “1” and vice versa.
(b) The ending PC value of CRM element “2” lies between the starting and ending PC value of CRM element “1” and vice versa.
(c) CRM element “2” starting and ending PC values of CRM element “2” lie within the starting and ending PC values of CRM element “1” and vice versa.
(d) The PC value of CRM element “2” is the same as the PC value of CRM element “1” and vice versa.

CRM element “1” PC values along the x-axis fetched for determining a set of disturbing CRM elements along the vertical axis. The starting and ending PC values of CRM element “1” are compared with the starting and ending PC values of CRM element “2”. There are different instances when the PC value of CRM element “2” may lie within the range of the PC value of CRM element “1” as stated below:
(a) The starting PC value of CRM element “2” lies between the starting and ending PC values of CRM element “1” and vice versa.
(b) The ending PC value of CRM element “2” lies between the starting and ending PC values of CRM element “1” and vice versa.
(c) The starting and ending PC values of CRM element “2” lie within the starting and ending PC values of CRM element “1” and vice versa.
(d) The PC value of CRM element “2” is the same as the PC value of CRM element “1” and vice versa.

In this specific implementation, if there is a single element, the wrapper will not be assigned after grouping process is completed because there is only one element and it has no disturbing component. A wrapper can be generated by wrapper generation unit 204 in CRM page design system 102 unit of FIG. 2. FIGS. 6A-C illustrate various examples for wrapping or grouping. In each example, the element “1” is selected and its PCs are obtained. The disturbing element for element “1” is determined to be “2”, along the vertical axis. There are no additional disturbing elements for element “1”, in examples in FIGS. 6A-C. Finally, a wrapper is generated and assigned to elements “1” and “2”.

FIGS. 6A-C are examples of wrapping two elements based on coordinates in vertical direction. In particular, FIG. 6A illustrates an example of wrapping two elements which lie on same coordinates along vertical direction. FIG. 6B illustrates another example of wrapping two elements which lies on different coordinates along vertical direction. FIG. 6C illustrates another example of wrapping two elements which lies on different coordinates along vertical direction (in step 1 and step 2).

FIG. 6D is an example of wrapping three elements which lies on different coordinates along vertical direction. In particular, FIG. 6D illustrates example of wrapping three elements which lies on different coordinates along vertical direction (in step 1 to 6)

In the example of FIG. 6D, step 1 illustrates a canvas with three elements 1, 2 and 4. In step 2, the element “1” is selected, and its PC are fetched. In step 3, the disturbing element for the element (1) is determined to be “4”. At step 4, element “2” is determined as the disturbing element for element “4”. At step 5, since there is no further disturbing elements for element “1” along the vertical axis, a wrapper is generated and assigned to elements (1,4,2) in step 6.

FIG. 7 is a master flowchart 700 depicting example operations of a layout building engine 106. In this and other flowcharts, flow diagrams, and/or sequence diagrams, the flowchart illustrates by way of example a sequence of steps and/or modules. It should be understood the modules may be reorganized for parallel execution, or reordered, as applicable. Moreover, some steps and/or modules that could have been included may have been removed to avoid providing too much information for the sake of clarity and some steps and/or modules that were included could be removed but may have been included for the sake of illustrative clarity.

The layout building engine 106 initiates the process of generating the layout by fetching the master CRM element set comprising CRM elements on a canvas (step 702). In step 704, If the element set contains more than one element, the engine checks for any hidden elements (step 706), if determined yes, the hidden elements are handled by absolute positioning of the elements (step 708) and at the next step, pre-grouping is performed. If determined no, pre-grouping is performed (step 710) to group near vertical or horizontal elements. Grouping operation in performed on the element set (step 712). At the next step 714, the engine checks if the grouped element set contains more than one element, if it is determined yes, sub-grouping is performed (step 716). If it is determined no, elements are aligned by wrapper configuration unit 206 (step 718). After sub-grouping, the engine checks whether the resultant set obtained is a separable element set (step 720), if determined yes, elements of the set are aligned by the separable element set alignment unit 208 of the wrapper configuration unit 206 and stored in a layout data (step 718). If determined no, the resultant set obtained is a non-separable element set (step 722). The elements of the set are aligned by the non-separable element set alignment unit 210 of the wrapper configuration unit 206 and stored in the layout data datastore 126.

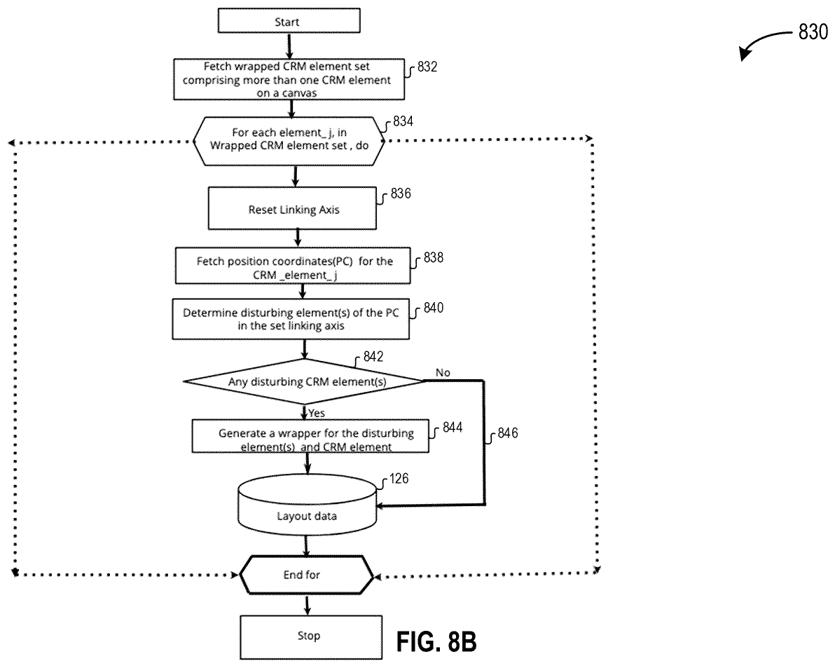

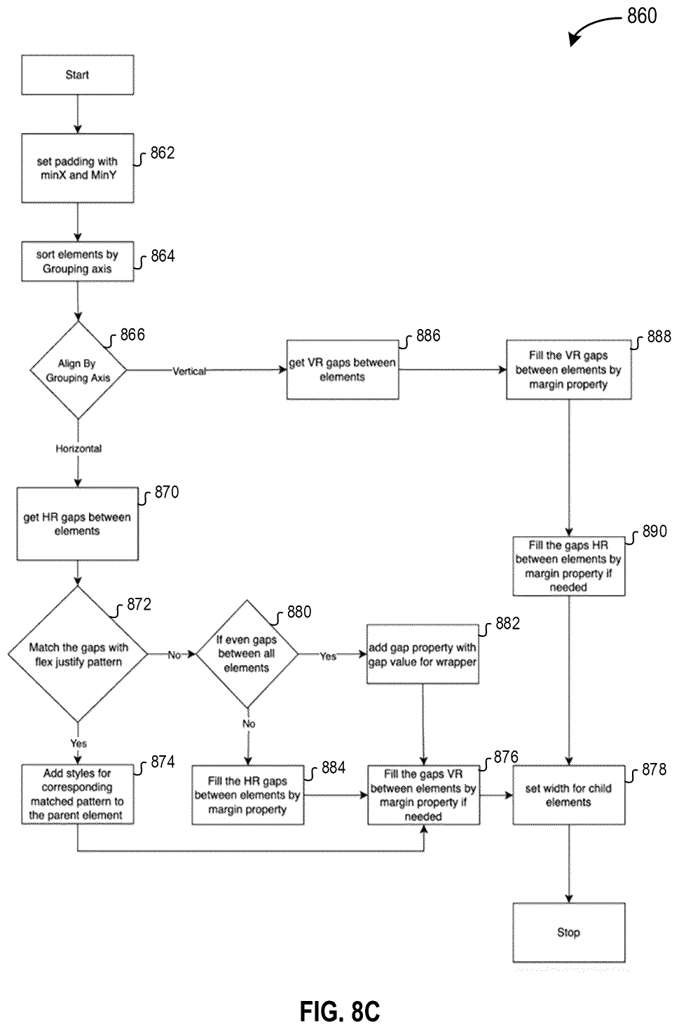

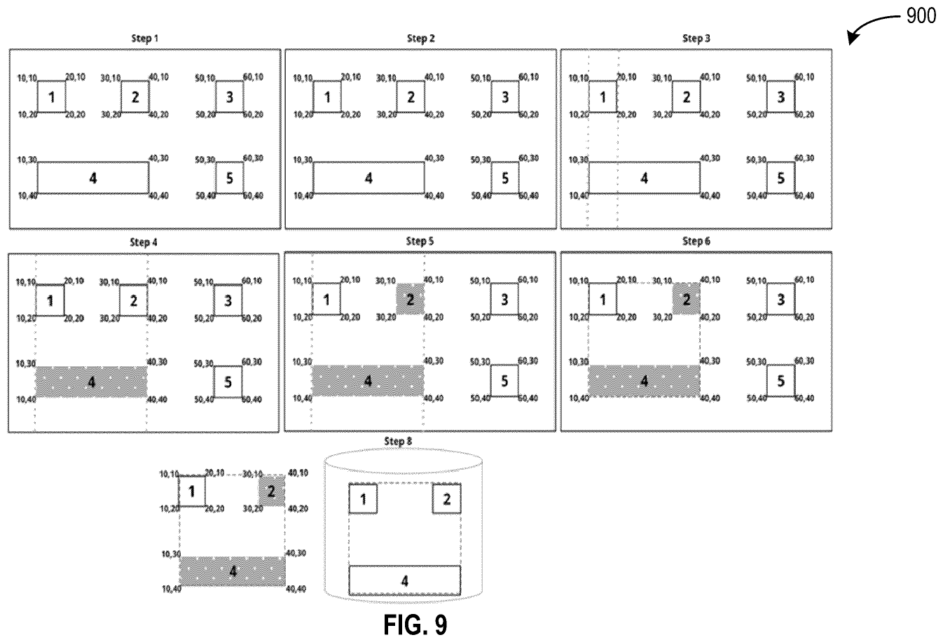

FIG. 8A is a flowchart 800 of an example CRM layout building engine 106 operation (e.g., grouping) to reduce wrapper count. In this and other flowcharts, flow diagrams, and/or sequence diagrams, the flowchart illustrates by way of example a sequence of steps and/or modules. It should be understood the modules may be reorganized for parallel execution, or reordered, as applicable. Moreover, some steps and/or modules that could have been included may have been removed to avoid providing too much information for the sake of clarity and some steps and/or modules that were included could be removed but may have been included for the sake of illustrative clarity.

In a specific implementation, the flowchart 800 depicting an example method for finding disturbing CRM elements. The operation is performed by the grouping unit 202 of the CRM layout building engine 106. The flowchart 800 starts at the module 802 with fetching a CRM element set, which for this example includes CRM elements on a canvas. The fetched element set comprises more than one CRM element. The flowchart 800 continues to the module 804 where the following is carried out for each CRM element in the CRM element set, say CRM_element_i. A linking axis is set, e.g., vertical axis for a vertical CRM use case (module 806). The PCs for a CRM element, say, CRM_element_i is fetched (step 808). The set of disturbing CRM elements corresponding to PC in the set linking axis is determined (step 810). According to step 812, if the set of disturbing CRM elements is not null for CRM_element_i along the linking axis, a wrapper is generated for the disturbing element(s) and CRM_element_i and stored in a layout data 126 (step 814). If it is determined that the set of disturbing CRM elements is null for CRM_element_i along the linking axis, the CRM elements are stored in a layout data (step 816).

FIG. 8B is a flowchart 830 of an example CRM layout building engine 106 operation (e.g., sub-grouping) to reduce wrapper count. In this and other flowcharts, flow diagrams, and/or sequence diagrams, the flowchart illustrates by way of example a sequence of steps and/or modules. It should be understood the modules may be reorganized for parallel execution, or reordered, as applicable. Moreover, some steps and/or modules that could have been included may have been removed to avoid providing too much information for the sake of clarity and some steps and/or modules that were included could be removed but may have been included for the sake of illustrative clarity.

In step 832, the wrapped CRM element set comprising more than one CRM element on a canvas are fetched. The following process (e.g., steps) are carried out for each wrapped CRM element set in the layout datastore 126, as indicated by step 834. In step 836, the linking axis is reset. At the next step 838, the PC for a CRM_element_j of the wrapped CRM element set is fetched. The set of disturbing CRM elements corresponding to PC in the set linking axis is determined (step 840). In step 842, if the set of disturbing CRM elements is not null for CRM_element_i along the linking axis, a wrapper is generated and assigned over the set of disturbing CRM element and stored in a layout data (step 844). If it is determined that the set of disturbing CRM elements is null for CRM_element_j along the linking axis, the CRM elements are stored in a layout data (step 846). The determined DCS is stored in the layout datastore 126. The operation of the flowcharts in FIG. 8A and FIG. 8B is further explained using a layout with “5” CRM element(s) as described below.

FIG. 8C is a flowchart 860 of an example functioning of a wrapper configuration unit 206 in CRM (e.g., after grouping). In this and other flowcharts, flow diagrams, and/or sequence diagrams, the flowchart illustrates by way of example a sequence of steps and/or modules. It should be understood the modules may be reorganized for parallel execution, or reordered, as applicable. Moreover, some steps and/or modules that could have been included may have been removed to avoid providing too much information for the sake of clarity and some steps and/or modules that were included could be removed but may have been included for the sake of illustrative clarity.

In the example of FIG. 8C, the element set is processed as separable alignment set and the properties for alignment, spacing, and dimensions are applied. First, it creates an initial space for the parent element by applying the padding property using the values of the child element's minX and minY (step 862). Then, it arranges the elements by sorting them (step 864) using the grouping axis to maintain the order (step 886). After that, the elements can be processed for inner spacing between them. For the X axis (which is also called the horizontal (HR) axis) (step 866): First, it checks the gaps between the elements in step 870. If the gaps match any of the justify patterns (space-between, center, space-around, space-evenly) (step 872), the layout building engine 106 adds (step 874) the respective property for the parent element (usually engine-generated wrappers). If the gap values between every pair of elements (step 880) is the same or equal, the engine applies the gap property to the wrapper (step 882). The elements with an equal gap between them are represented as even gap elements. If the gaps do not have the same values (step 884), the margin property is applied to the child elements. The Y axis (which is also called the vertical (VR) axis) gets the vertical gap between the elements (step 886) and fills the vertical elements by margin property (step 888). The engine finds and fills both axis gaps using the margin property (e.g., in steps 884, 876, 890). Finally, the engine sets the min-height, width, and direction properties before exiting the process (step 878).

The process of FIGS. 8A-B is described below using a sample layout with “5” CRM elements (elements). The main element set={1,2,3,4,5} is fetched from element data storage. A linking axis, e.g., vertical linking axis, is fetched. The process begins with the selection of a vertical linking axis because a vertical CRM use case is preferred by users. Else, if the user prefers a horizontal CRM use case, then the process could begin with the selection of a horizontal linking axis.

FIG. 9 is a diagram 900 of an example wrapper along the vertical axis around elements (1, 4, 2). At step 1, the main element set {1,2,3,4,5} is fetched. At step 2, The element “1” is selected, and its PCs are fetched. At step 3, the disturbing element for the element (1) is determined, and the determined disturbing element is “4”. At step 4, element “2” is determined as the disturbing element for element “4”. At step 5, since there is no further disturbing elements for element “1” along the vertical axis, a wrapper is generated and assigned to elements (1,4,2) in step 6. The element set is updated and becomes {3,5,(1,4,2)}. Here (1,4,2) is the child elements for the wrapper. The updated element set is stored in layout data.

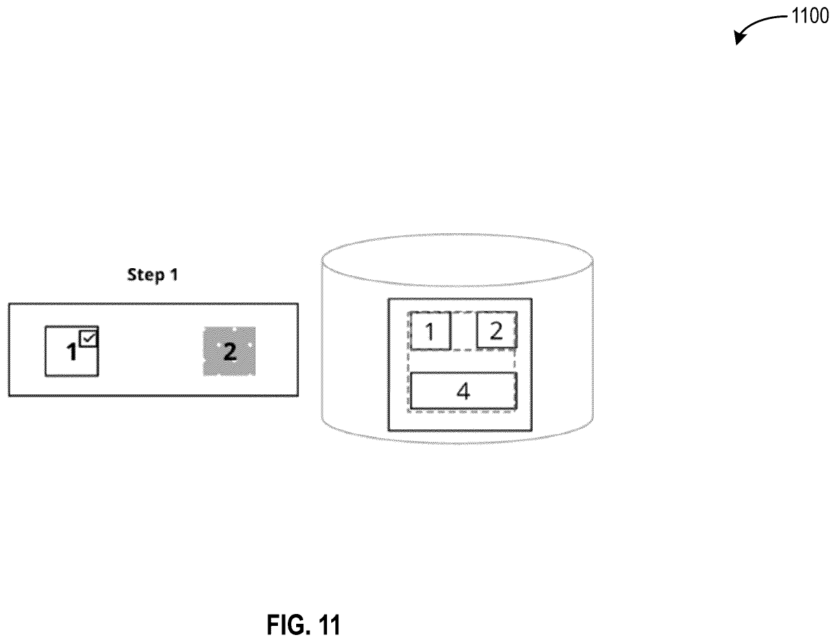

FIG. 10 is a diagram 1000 of an example wrapper along a horizontal axis around elements (1, 2). Now the element set (1,4,2) is processed for further grouping. At step 1, The element “1” is selected, and its PCs are fetched.

At step 2, the disturbing element for the element (1) is determined, and the disturbing element is “2”. At step 3, the wrapper is assigned to (1,2). The element set is updated and becomes {3,5,((1,2)4)}. Here (1,2) and (4) are the child elements of its respective wrappers. The updated element set is stored in layout data.

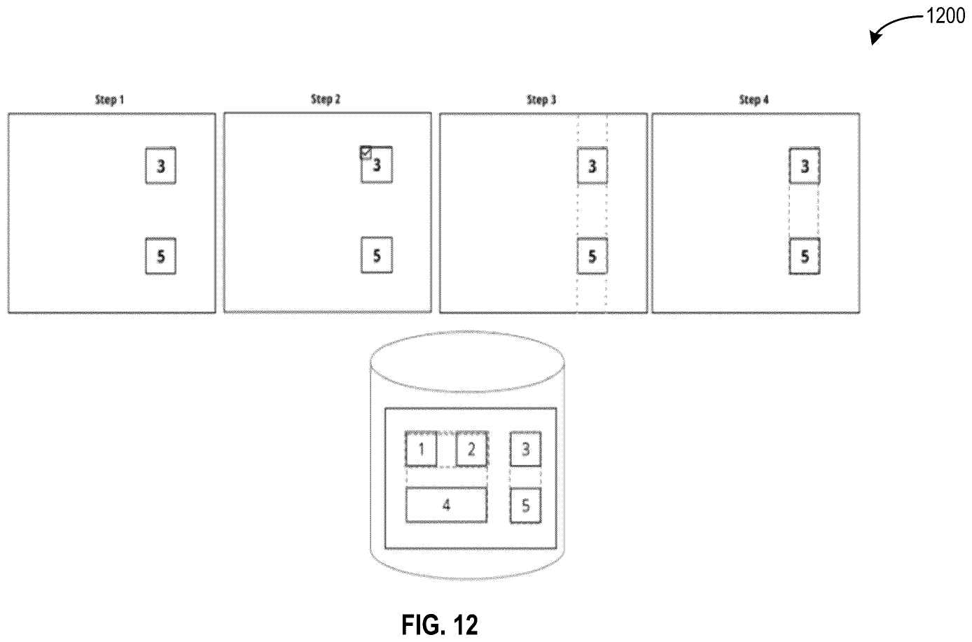

FIG. 11 is a diagram 1100 of an example further grouping or sub-grouping of elements (1, 2). For further grouping or sub-grouping elements (1,2) is processed as shown in FIG. 11. The element “1” is selected, and its PCs are fetched. No disturbing element is found. Next, for the element “2”there is No disturbing element found and no further grouping takes place.

No further grouping or sub-grouping is done for element (4) as it is a single element. The element “4” is selected, and its PCs are fetched. No disturbing element is found. There is no further grouping or sub-grouping process for the elements ((1,2)4). The element set {3,5,((1,2)4)} is stored in layout data. Next, the grouping or sub-grouping process is performed for the elements 3 and 5.

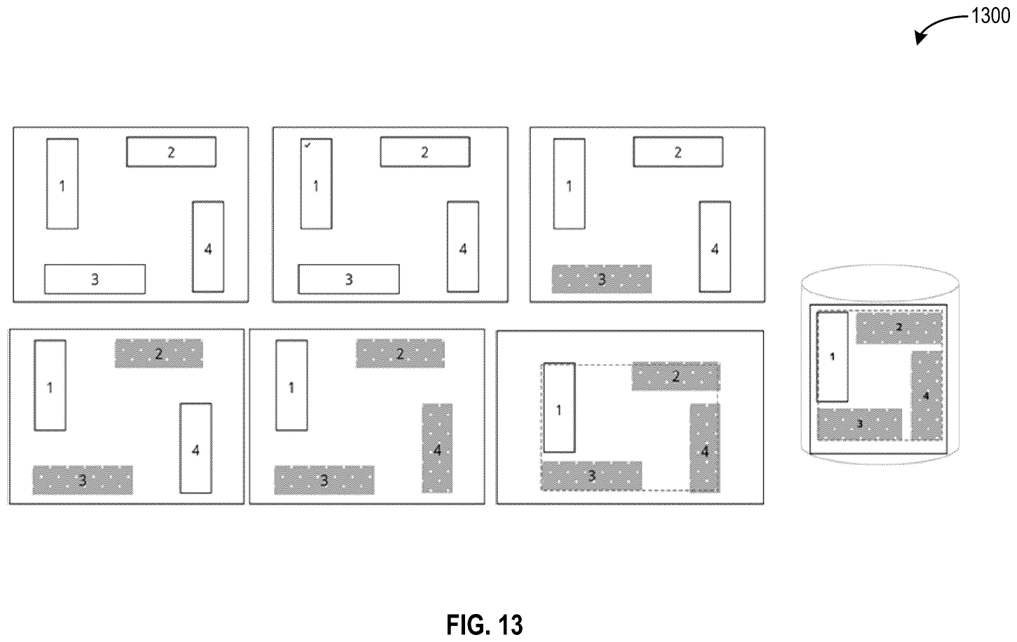

FIG. 12 is a diagram 1200 of an example wrapper along vertical axis around elements (3,5). At step 1, elements (3,5) is fetched. At step 2, The element “3” is selected, and its PCs are fetched. At step 3, the disturbing element for the element (3) is determined, and the determined disturbing element is “5”. At step 4, the wrapper is assigned to (3,5). Here(3,5) is the child elements of its wrapper. The element set is updated and stored in layout data as {((1,2),4), (3,5)}.

For further grouping or sub-grouping element (3,5) along horizontal axis is performed. The element “3” is selected, and its PCs are fetched. No disturbing element is found. The element {3} is stored in layout data. The element “5” is selected, and its PCs are fetched. No disturbing element is found. As there is no disturbing element found, no further grouping or sub-grouping process takes place for the element set (3,5).

The element set is updated as {((1,2),4), (3,5)} and stored in layout data. Here ((1,2),4) and (3,5) are the child elements of its respective wrappers. The resultant set obtained is a separable element set because no further grouping or sub-grouping takes place as there is no disturbing element.

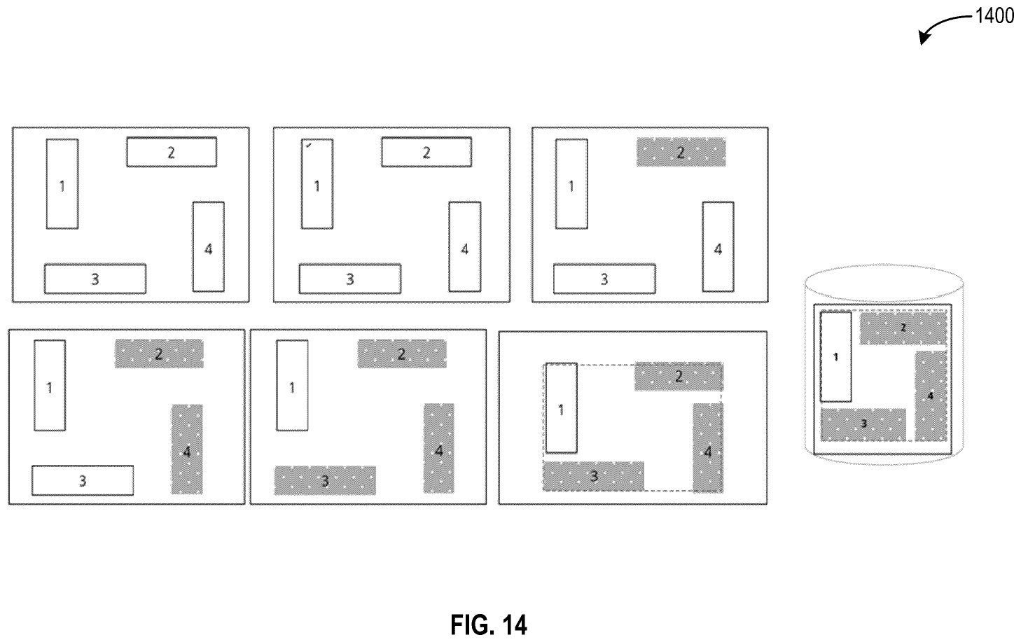

FIG. 13 is a diagram 1300 of an example wrapper along vertical axis for elements (1,3,2,4). At step 1, the main element set {1,2,3,4} is fetched. At step 2, The element “1” is selected, and its PCs are fetched. At step 3, the disturbing element for the element (1) is determined along the vertical axis, and the determined disturbing element is “3”. At step 4, element “2” is determined as the disturbing element for element “3”. At step 5, element “4” is determined as the disturbing element for element “2”. A wrapper is generated and assigned to elements (1,3,2,4). The element set is updated and becomes {(1,3,2,4)}. Here (1,3,2,4) is the child elements for the wrapper. The updated element set is stored in layout data. As all the elements are disturbing elements for each other i.e., the disturbing elements are not reduced to zero the grouping continues indefinitely

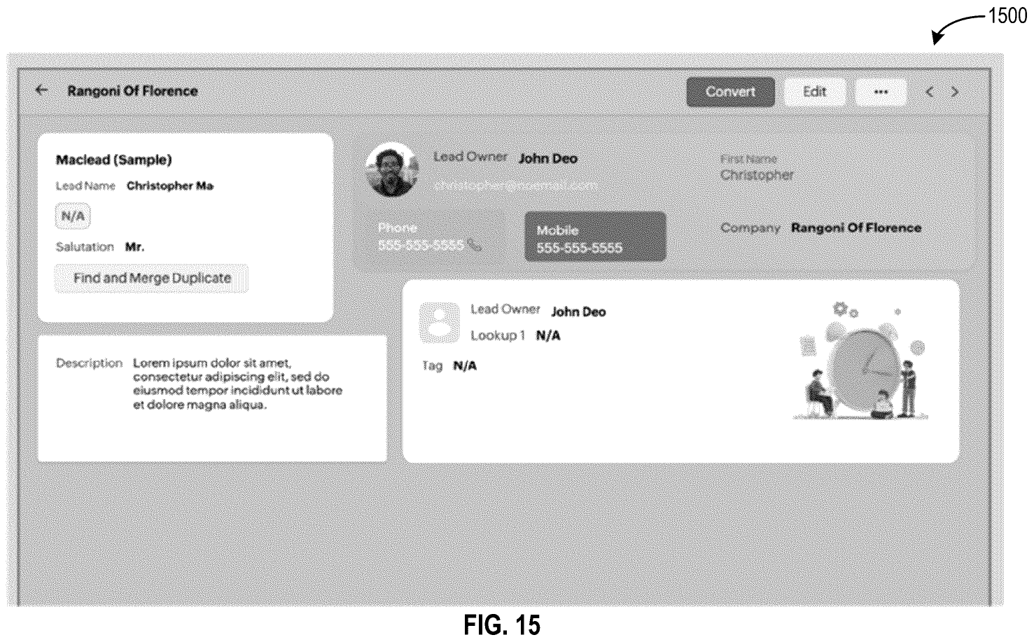

FIG. 14 is a diagram 1400 of an example wrapper along horizontal axis for elements (1,2,4,3). At step 1, the main element set {1,2,3,4,} is fetched. At step 2, The element “1” is selected, and its PCs are fetched. At step 3, the disturbing element for the element (1) is determined along the horizontal axis, and the determined disturbing elements are “2” and “4”. At step 4, element “3” is determined as the disturbing element for element “4”. At step 5, a wrapper is generated and assigned to elements (1,2,4,3). The element set is updated and becomes {(1,2,4,3)}. Here (1,2,4,3) is the child elements for the wrapper. The updated element set is stored in layout data. As all the elements are disturbing elements for each other, i.e., the disturbing elements are not reduced to zero the grouping continues indefinitely.

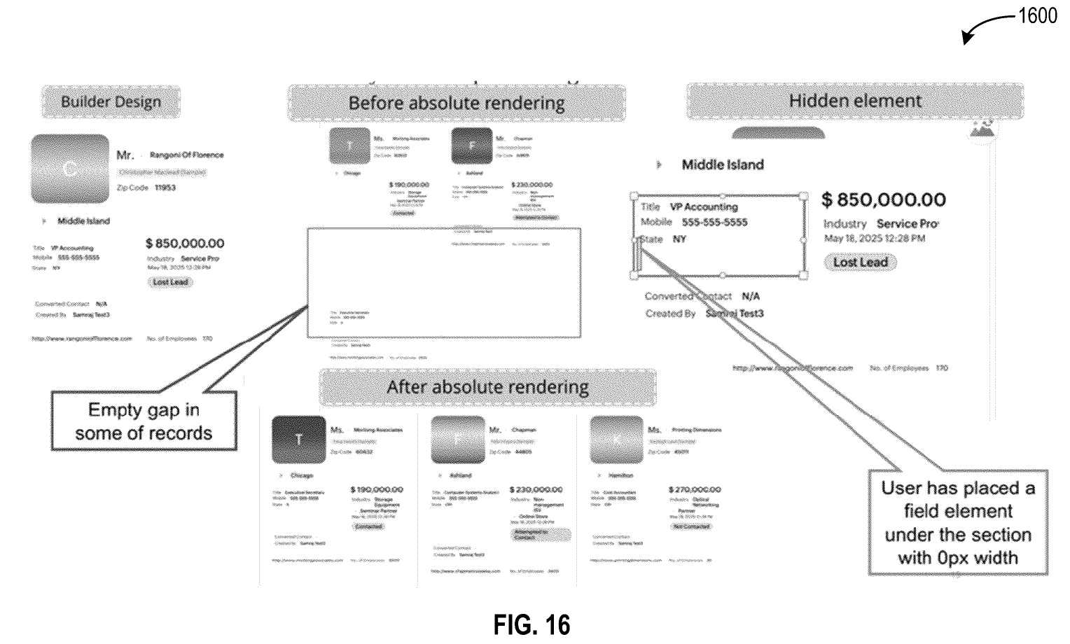

The resultant set obtained is a non-separable element set because all the elements are disturbing elements for each other i.e., the disturbing elements are not reduced to zero the grouping continues indefinitely. To handle this continuous non-definite grouping, the non-separable element set is aligned as a grid by wrapper configuration unit 206. The non-separable element set configuration unit supports the wrapper in placing the CRM elements in a grid to handle the alignment of the non-separable element set, as shown in FIG. 15.

FIG. 15 is a diagram 1500 illustrating an example handling of a non-separable element set.

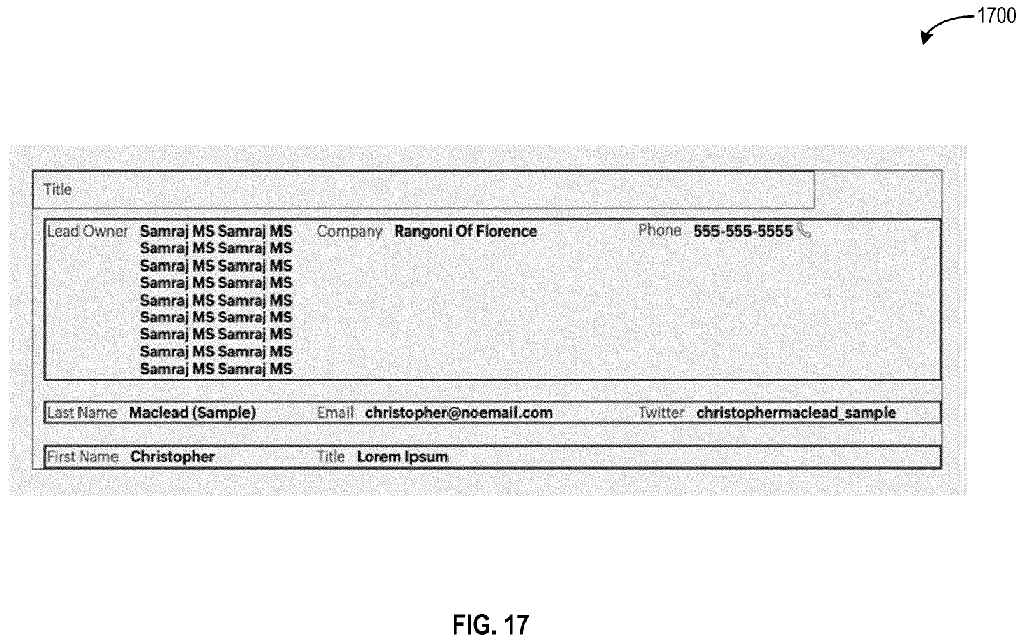

FIG. 16 is a diagram 1600 illustrating an example hidden element handled by an absolute positioning module 212. In the example of FIG. 16, the hidden element is handled by the absolute positioning module 212. The user has placed a field element under the section with a width of 0 px. The field's height will grow based on the record data, but since it has a width of 0 px, it may appear as an empty gap in some records. To fix this, the hidden element can be rendered in an absolute position. This means that the hidden element will not affect the placement of any other elements. As a result, the layout will behave normally.

### Pre-Grouping

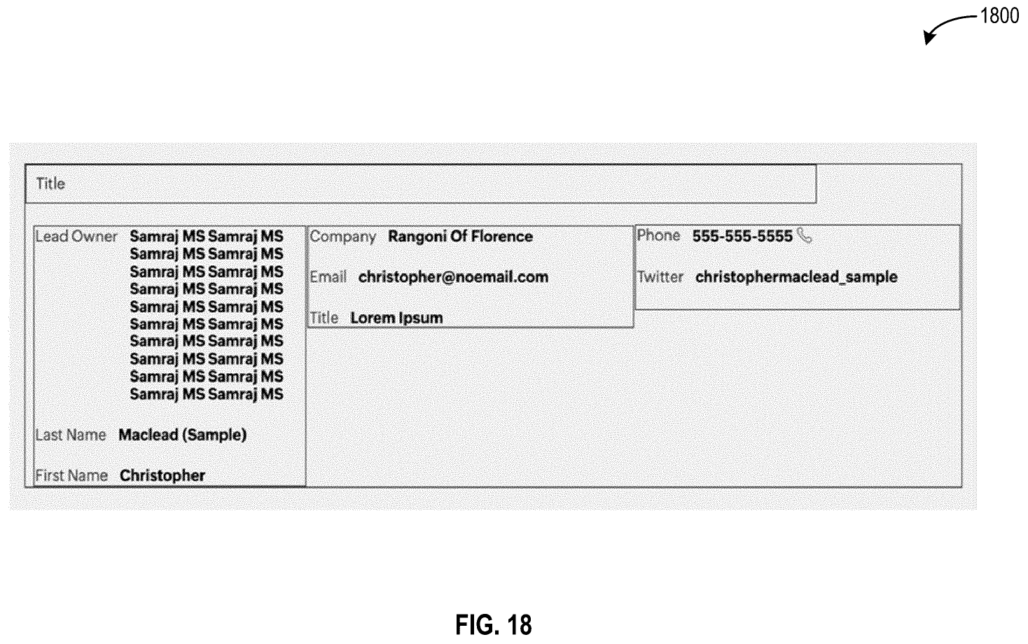

In a specific implementation, if there is more than one element in an element set, pre-grouping is implemented to group a near vertical axis elements or a near horizontal axis elements. This is done to enhance visual appeal to users. For example, in FIG. 17, assume there are 9 elements in 3×3 rows and columns, without pre-grouping the enhanced grouping process generates a 3 row layout, as “Title” is a disturbing element vertically for the element set. Since it is generated as a row layout, if “Lead owner” content increases, the 2nd and 3rd row elements will be affected. Pre-grouping overcomes this disadvantage, as depicted in FIG. 18, by grouping the near vertical elements in a column

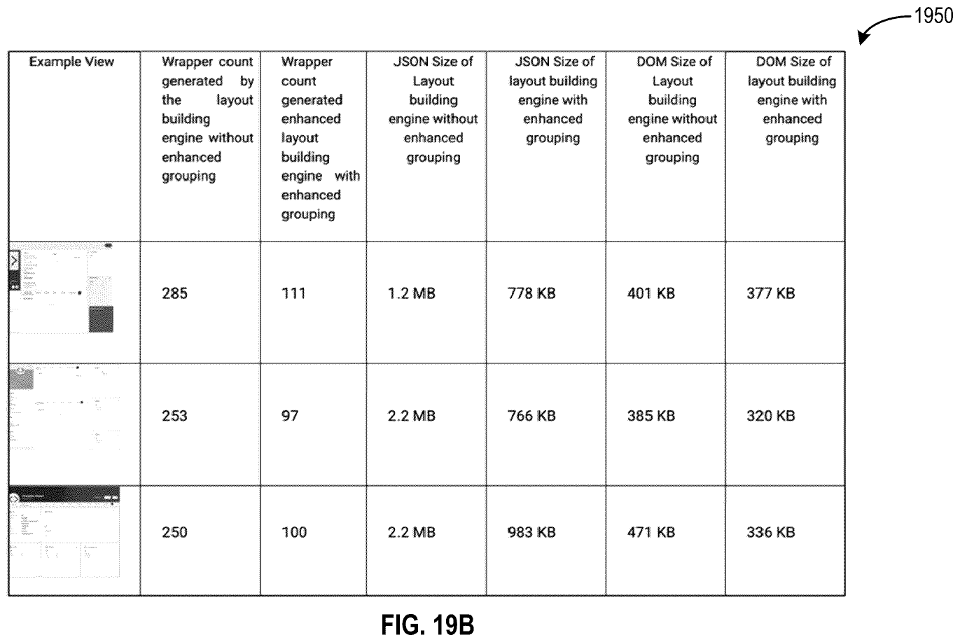

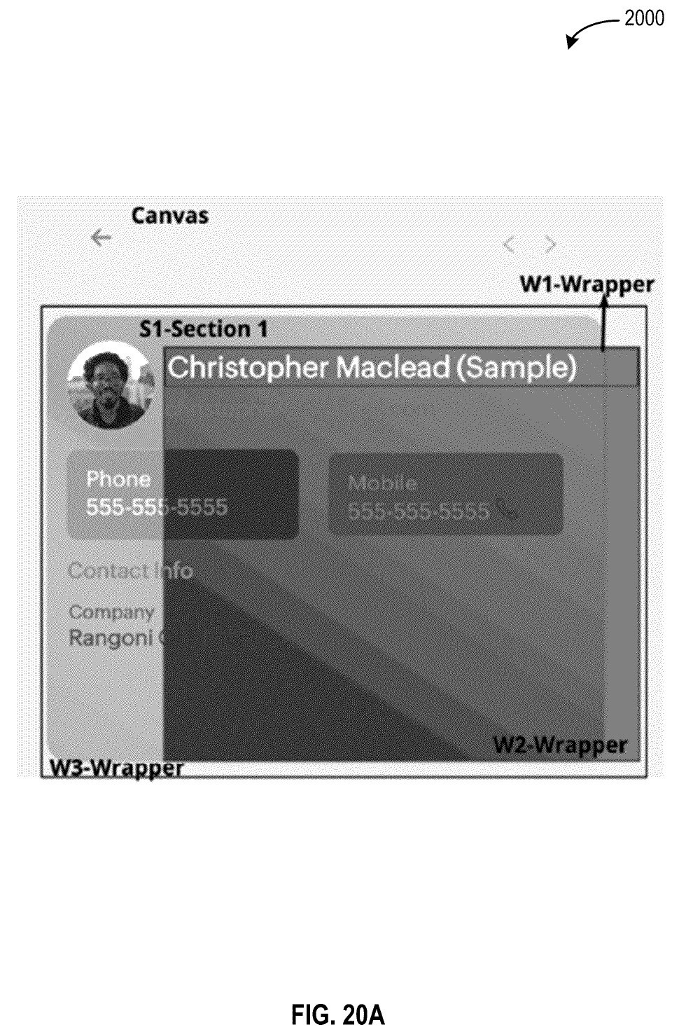

FIG. 17 is a screenshot 1700 of an example without pregrouping. FIG. 18 illustrates a screenshot 1800 of an example after pregrouping. FIG. 19A illustrates a screenshot 1900 of an example count difference using the enhanced layout building engine 106 in FIG. 1.

FIG. 19B illustrates a screenshot 1950 of an example count difference and JSON, DOM size difference using the enhanced layout building engine 106.

The advantage of this enhanced grouping technique is to reduce wrapper count generated by the layout building engine 106. Reduced wrapper count results in minimized memory usage and improves the performance of the layout building engine 106. FIG. 16A is a sample screenshot showcasing the reduced wrapper count (refer to the wrapper count generated by the enhanced layout building engine 106) achieved in grouping the CRM elements. Grouping takes place only if a disturbing node is determined. A wrapper is created only when a disturbing element is determined. This reduces the wrapper generated by the layout building engine 106. FIG. 16B is a sample screenshot showcasing reduced JSON, DOM size.

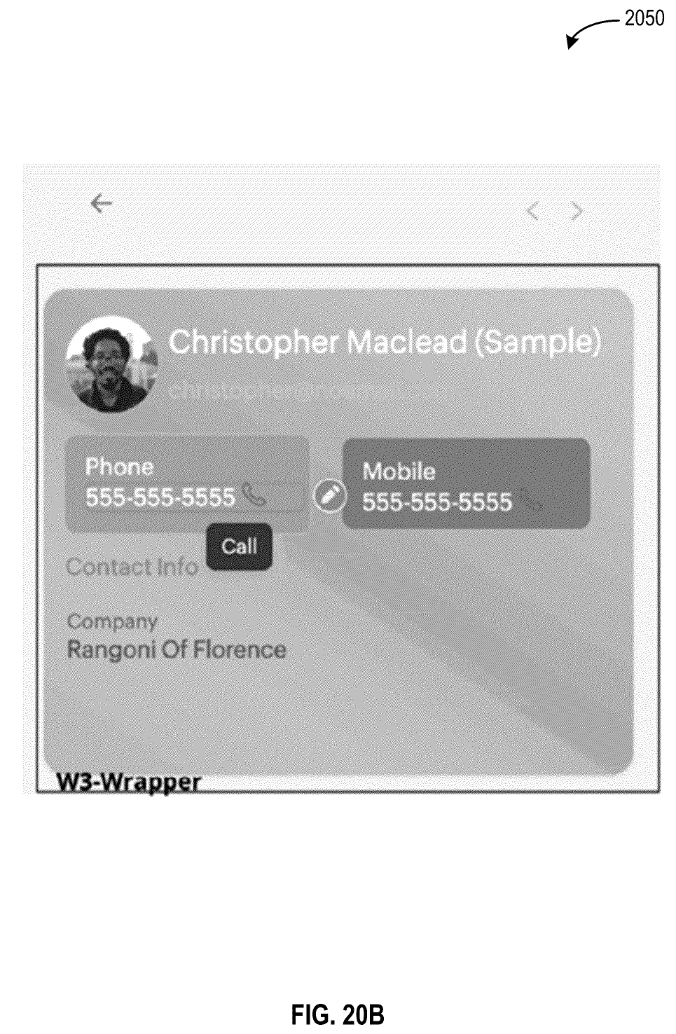

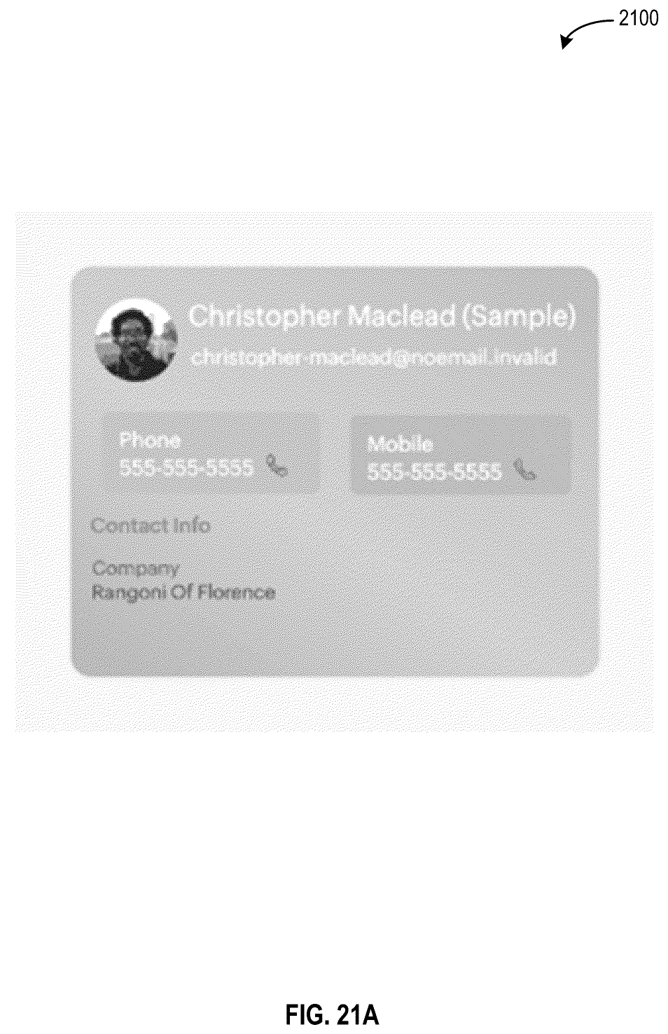

FIG. 20A illustrates a screenshot 2000 of an example rendering of CRM element without enhanced grouping by the layout building engine 106. In the example of FIG. 20A, each element has a minimum of 2 wrappers, say, a first wrapper W1, a second wrapper W2, and a third wrapper W3 in section S1 of a canvas. The first wrapper W1 holds its child element “Christopher Maclead”. The second wrapper W2 holds the Wrapper W1. The second wrapper W2 is the parent wrapper for W1. The second wrapper W2 will handle W1's properties for alignment. The wrapper W2's height keeps growing till its parent wrapper W3. Wrapper W3 is grouped on a vertical axis, and its child wrapper W2 tends to grow based on the height of W3. This causes the elements positioned beneath the wrapper W2 not to be accessible due to the hindrance posed by the wrapper W2, making it difficult to reach or interact with target elements such as “Phone”. Henceforth, the user cannot access the phone details.

FIG. 20B illustrates a screenshot 2050 of an example rendering of CRM element with enhanced grouping by the layout building engine 106. In FIG. 20B, the enhanced layout building engine 106 reduces the wrappers by eliminating W1 and W2. This prevents the possibility of additional wrappers such as W2 covering the actual CRM element. As a result, a target element, say “Phone” is accessed. Therefore, the enhanced layout building engine 106 provides efficient rendering

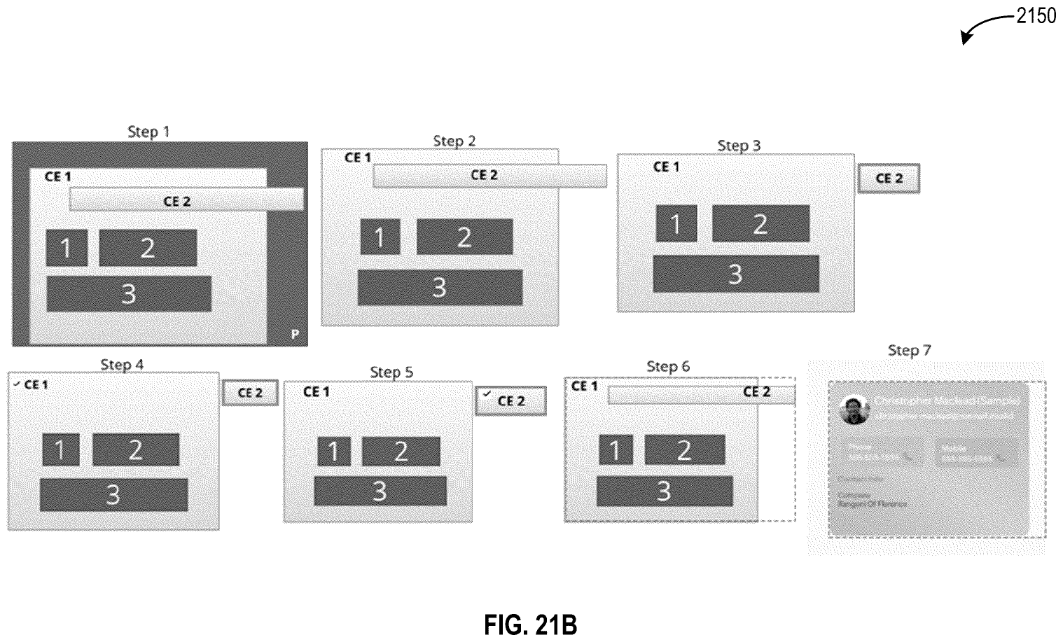

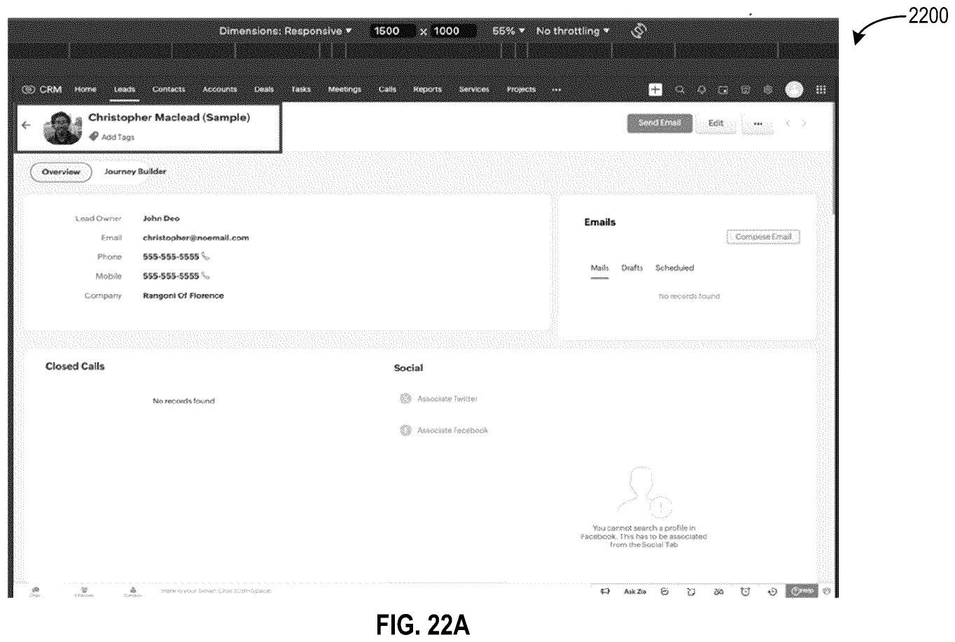

FIG. 21A illustrates a screenshot 2100 of an example user design layout. The user design layout as shown in FIG. 21A is used in demonstrating the process involved in enhanced grouping technique. The enhanced grouping technique is illustrated in FIG. 21B.

FIG. 21B is a flowchart 2150 of an example enhanced grouping. In this and other flowcharts, flow diagrams, and/or sequence diagrams, the flowchart illustrates by way of example a sequence of steps and/or modules. It should be understood the modules may be reorganized for parallel execution, or reordered, as applicable. Moreover, some steps and/or modules that could have been included may have been removed to avoid providing too much information for the sake of clarity and some steps and/or modules that were included could be removed but may have been included for the sake of illustrative clarity.

In FIG. 21A, the user design layout has two child elements that are overlapped with each other, as shown in FIG. 21B, Step 1. In Step 2, the child elements are separated from the parent, and in Step 3, the overlapped child element of CE2 is resized before being grouped. In Step 4, the element (i) is selected from the element set, and the disturbing element is checked. No disturbing element is found and no wrapper is assigned. In Step 5, another element (i) is selected from the element set and no disturbing element is found and no wrapper is assigned. In Step 6, in the final stage, the overlapped element is resized back to its original position and only one wrapper is assigned for all child elements. The final output is presented in the last step.

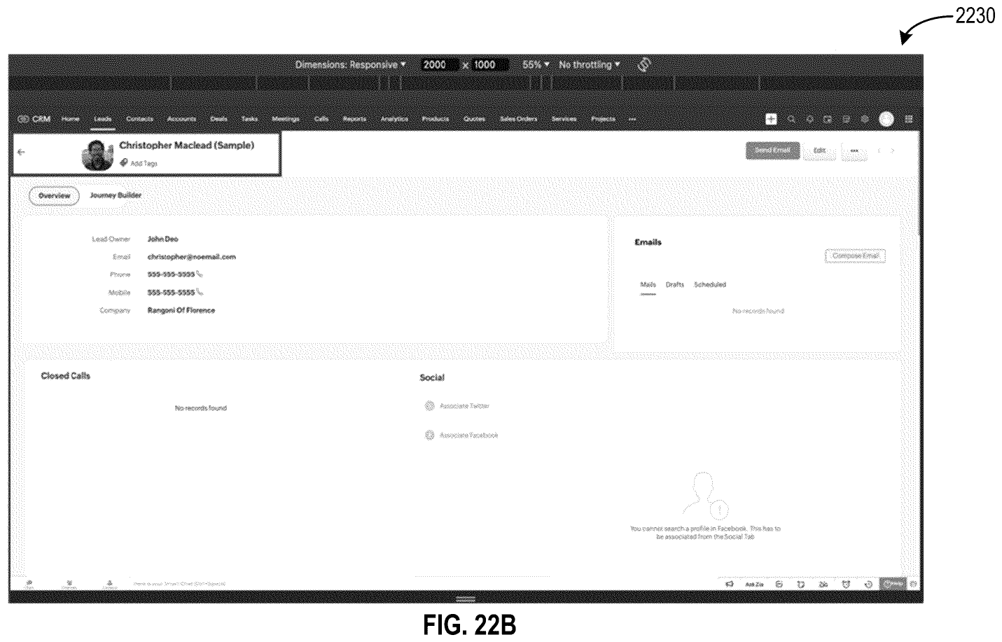

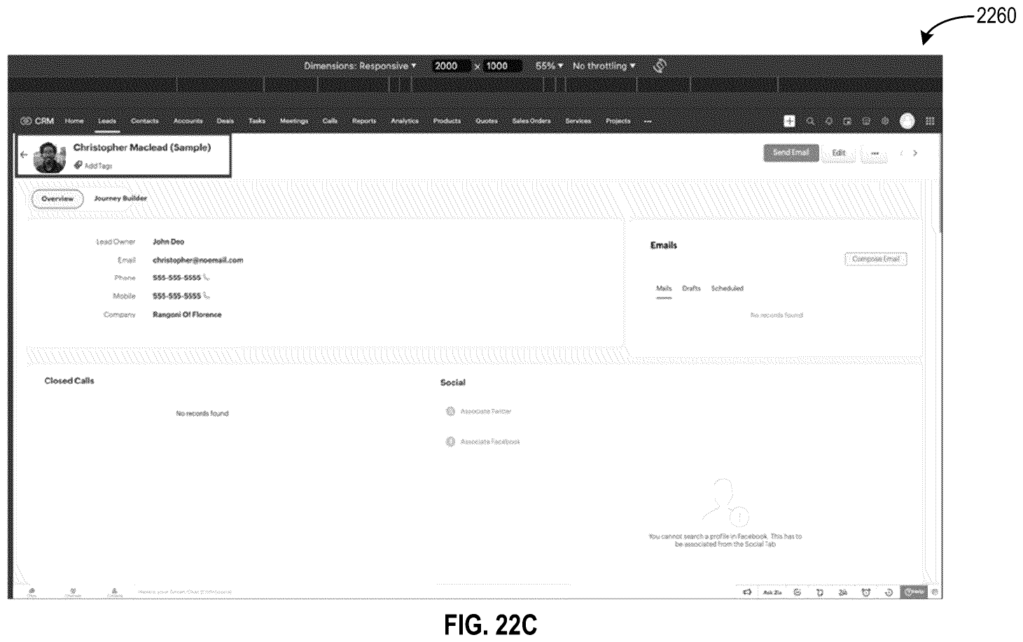

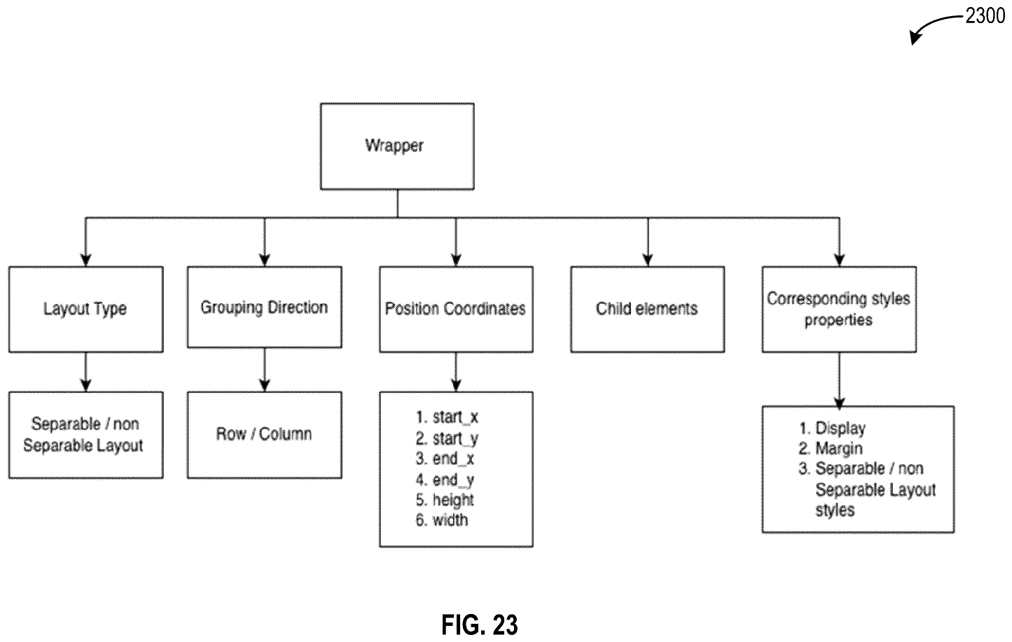

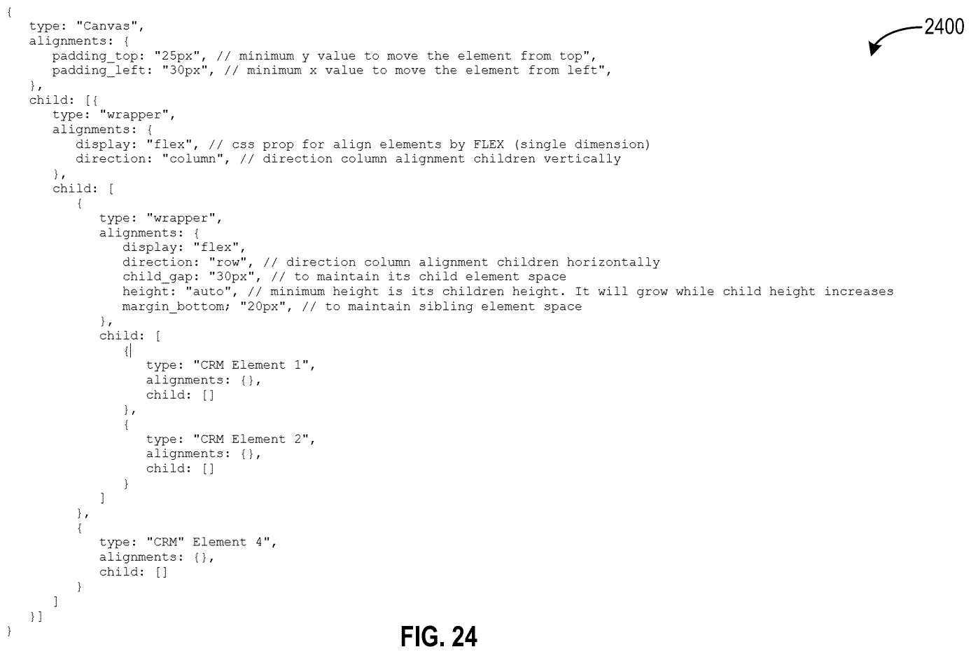

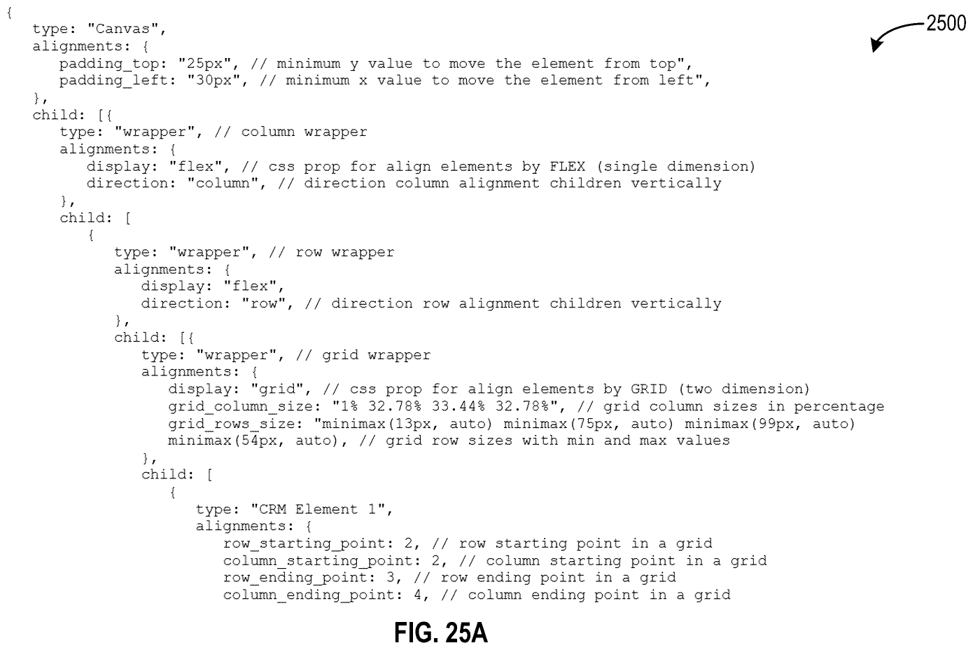

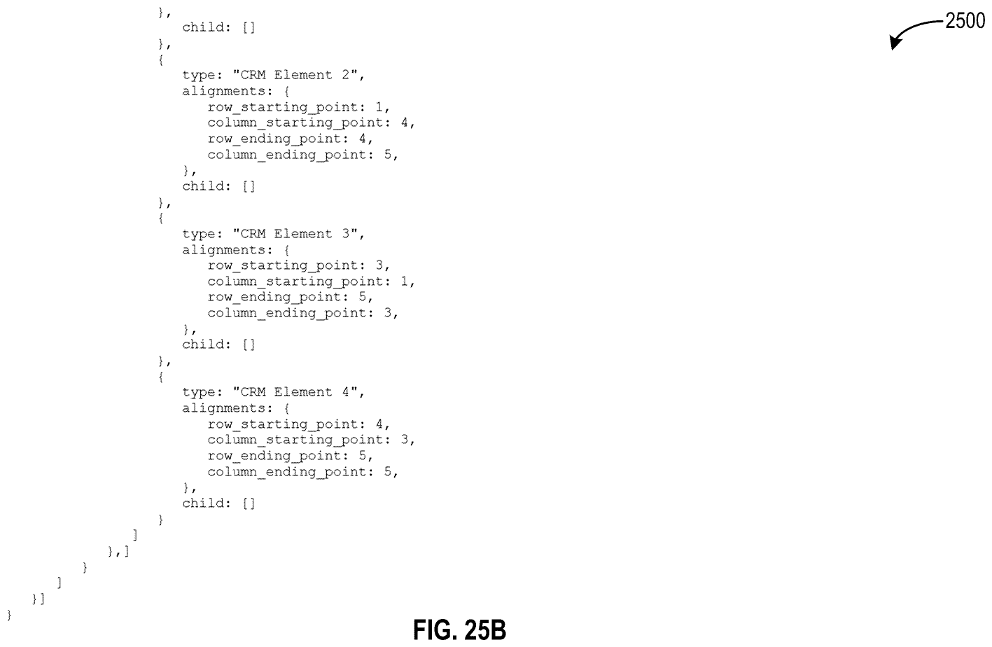

FIG. 22A is a screenshot 2200 of an example actual screen size of a CRM Page. FIG. 22B is a screenshot 2230 of an example expanded screen size without wrapper configuration. FIG. 22C is a screenshot 2260 of an example expanded screen size with wrapper configuration. FIG. 23 is a diagram 2300 of an example tree data structure of a wrapper. FIG. 24 illustrates pseudo code 2400 for an example separable set. FIG. 25A and FIG. 25B illustrate pseudo code 2500 for an example non-separable set.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

What is claimed is:

1. A system comprising:
one or more processors; and
memory storing instructions that, when executed by the one or more processors, cause the system to perform:
generating a canvas;
fetching a customer relationship management (CRM) element set, wherein the CRM element set includes a plurality of different CRM elements on the canvas;
for each CRM element in the CRM element set:
setting a linking axis;
fetching corresponding position coordinates for a respective CRM element of the plurality of different CRM elements;
determining one or more disturbing elements corresponding to the positional coordinates in the set linking axis;
generating, in response to determining the one or more disturbing elements, a respective wrapper for the one or more disturbing elements and the respective CRM element of the plurality of different CRM elements;
storing the wrapper in a layout datastore.

2. The system of claim 1, wherein the instructions when executed by the one or more processors, cause the system to perform:
fetching the wrapped one or more disturbing elements and the respective CRM elements of the plurality of different CRM elements;
for each element of the wrapped one or more disturbing elements and the respective CRM elements of the plurality of different CRM elements:
resetting the linking axis;
fetching the position coordinates of a respective element of the wrapped one or more disturbing elements and the respective CRM elements of the plurality of different CRM elements;
determining one or more additional disturbing elements corresponding to the position coordinates in the set linking axis;
generating an additional wrapper for the one or more additional disturbing elements and a respective additional CRM element of the plurality of different CRM elements.

3. The system of claim 2, wherein the linking axis comprises a horizontal linking axis.

4. The system of claim 2, wherein the linking axis comprises a vertical linking axis.

5. The system of claim 2, wherein the canvas comprises a canvas of a graphical user interface of an associated CRM application.

6. The system of claim 5, wherein the graphical user interface comprises a no-code drag-and-drop graphical user interface.

7. The system of claim 6, wherein the CRM element set is fetched in response to a user dragging the CRM elements from a selection pane of the graphical user interface and dropped on the canvas by a user while the user is designing a CRM page.

8. The system of claim 7, wherein the instructions when executed by the one or more processors, cause the system to perform:
determining a first CRM element of the CRM elements overlaps a second CRM element of the CRM elements;
resizing, in response to the determination, the first CRM element such that the first CRM element does not overlap the second CRM element.

9. The system of claim 8, wherein the resizing is performed at runtime.

10. The system of claim 1, wherein the instructions when executed by the one or more processors, cause the system to perform managing, by a wrapper configuration unit, the arrangement of the elements on the canvas.

11. A method comprising:
generating a canvas;
fetching a customer relationship management (CRM) element set, wherein the CRM element set includes a plurality of different CRM elements on the canvas;
for each CRM element in the CRM element set:
setting a linking axis;
fetching corresponding position coordinates for a respective CRM element of the plurality of different CRM elements;
determining one or more disturbing elements corresponding to the positional coordinates in the set linking axis;
generating, in response to determining the one or more disturbing elements, a respective wrapper for the one or more disturbing elements and the respective CRM element of the plurality of different CRM elements;
storing the wrapper in a layout datastore.

12. The method of claim 11, comprising:
fetching the wrapped one or more disturbing elements and the respective CRM elements of the plurality of different CRM elements;
for each element of the wrapped one or more disturbing elements and the respective CRM elements of the plurality of different CRM elements:
resetting the linking axis;
fetching the position coordinates of a respective element of the wrapped one or more disturbing elements and the respective CRM elements of the plurality of different CRM elements;
determining one or more additional disturbing elements corresponding to the position coordinates in the set linking axis;
generating an additional wrapper for the one or more additional disturbing elements and a respective additional CRM element of the plurality of different CRM elements.

13. The method of claim 12, wherein the linking axis comprises a horizontal linking axis.

14. The method of claim 12, wherein the linking axis comprises a vertical linking axis.

15. The method of claim 12, wherein the canvas comprises a canvas of a graphical user interface of an associated CRM application.

16. The method of claim 15, wherein the graphical user interface comprises a no-code drag-and-drop graphical user interface.

17. The method of claim 16, wherein the CRM element set is fetched in response to a user dragging the CRM elements from a selection pane of the graphical user interface and dropped on the canvas by a user while the user is designing a CRM page.

18. The method of claim 17, comprising:
determining a first CRM element of the CRM elements overlaps a second CRM element of the CRM elements;
resizing, in response to the determination, the first CRM element such that the first CRM element does not overlap the second CRM element.

19. The method of claim 18, wherein the resizing is performed at runtime.

20. The method of claim 11, comprising managing, by a wrapper configuration unit, the arrangement of the elements in the canvas.
